(19) United States
(12) Patent Application Publication
(10) Pub. No.: US 2011/0161358 A1
(43) Pub. Date: Jun. 30, 2011

(54) MOBILE PHONE APPARATUS, CONFIRMATION INFORMATION DISPLAYING PROGRAM, CONFIRMATION INFORMATION DISPLAYING METHOD AND TRANSMITTING METHOD OF MOBILE PHONE APPARATUS

(75) Inventor: Keisuke Nagata, Osaka (JP)

(73) Assignee: KYOCERA CORPORATION, Kyoto-shi (JP)

(21) Appl. No.: 12/975,268

(22) Filed: Dec. 21, 2010

(30) Foreign Application Priority Data
Dec. 24, 2009 (JP) 2009-292534
Jan. 27, 2010 (JP) 2010-015970

(51) Int. Cl. G06F 17/30; G06F 3/048

(52) U.S. Cl. 707/769; 715/810; 707/E17.014

(57) ABSTRACT

A mobile phone apparatus 10 has a RAM (RANDOM ACCESS MEMORY) 34 to which address book data (1040) is stored, and the address book data (1040) is made up of address data, such as “YAMADA *ROU” and “YAMADA #ROU”. When a user performs a phone call or a mail sending operation on a key input device 26 in a state that the address data of “YAMADA #ROU” is selected, a processor 24 determines whether or not there is address data having a family name the same or similar to “YAMADA #ROU” in the address book data (1040). Then, the processor 24 displays a confirmation message on a display 30 in a case that it is determined that there is the address data having the same or similar family name.

### CROSS REFERENCE OF RELATED APPLICATION

The disclosure of Japanese Patent Application Nos. 2009-292534 and 2010-015970 are incorporated herein by reference.

### BACKGROUND OF THE INVENTION

1. Field of the Invention

The present invention relates to a mobile phone apparatus, a confirmation information displaying program, a confirmation information displaying method and a transmitting method of the mobile phone apparatus. Especially, the present invention relates to a mobile phone apparatus, a confirmation information displaying program, a confirmation information displaying method and a transmitting method of the mobile phone apparatus that can be able to transmit on the basis of a designated address.

2. Description of the Related Art

Conventionally, a mobile phone apparatus that can make a phone call on the basis of the designated address has widely been known, and one example of this kind of an apparatus is disclosed in Japanese Patent Application Laid-Open No. 2009-163353 [G06F 13/00] laid-open on Jul. 23, 2009. The information processing apparatus of the related art detects a character string of a destination from an e-mail text, acquires an address that matches an attribute of the destination from an address book, and displays an error in a case that the destination of the e-mail does not match the destination of the address. If there are a plurality of addresses that match the attribute of the destination, an alarm screen is displayed.

Furthermore, in a related art disclosed in Japanese Patent Application Laid-Open No. 2001-230802 [H04L 12/54, H04L 12/58, G06F 13/00] laid-open on Aug. 24, 2001, as an e-mail erroneous transmission preventive art, it is said that from the belonging and name of a selected e-mail address, similar e-mail address is determined, and the presence of the similar e-mail address is displayed.

However, in the first related art, if the character string of the destination itself is wrong, it is conceivable that an unnecessary error screen is displayed, or a necessary error screen is not normally displayed. Furthermore, if the character string of the destination is a vague representation, such as “to whom it may concern at **division”, a plurality of destination addresses corresponding to one destination exist, and even if there is an erroneously set destination address, an operator cannot notice it.

Furthermore, in the second related art, in a case that an e-mail sending destination is selected from a transmitting history and a receiving history of e-mail, it is impossible to prevent an erroneous sending when dissimilar email addresses displayed so as to be adjacent to each other on the screen is selected according to an erroneous key operation by the user from occurring.

### SUMMARY OF THE INVENTION

Therefore, a primary object of the present invention is to provide a novel mobile phone apparatus, a novel confirmation information displaying program, a novel confirmation information displaying method and a novel transmitting method of the mobile phone apparatus.

Another object of the present invention is to provide a mobile phone apparatus, a confirmation information displaying program, a confirmation information displaying method and a transmitting method of the mobile phone apparatus that are able to reduce an erroneous transmission.

The present invention employs following features in order to solve the above-described problems. It should be noted that reference numerals inside the parentheses and the supplementary explanations show one example of a corresponding relationship with the embodiments described later for easy understanding of the present invention, and do not limit the present invention.

A first invention is a mobile phone apparatus having a transmission destination information database being made up of transmission destination information, selectively displaying the transmission destination information making up of the transmission destination information database, and capable of transmitting based on the transmission destination information, wherein an operator which accepts a selecting operation of the transmission destination information, and accepts a transmitting operation to a transmission destination indicated by the selected transmission destination information; a determiner which determines whether or not transmission destination information in relation to the selected transmission destination information is included in the transmission destination information database when the operator accepts the transmitting operation based on the selected transmission destination information; and a displayer which displays confirmation information when the determiner determines that the transmission destination information in relation to the selected transmission destination information is included.

In the first invention, a mobile phone apparatus (10) has a transmission destination information database (1040, history data) being made up of transmission destination information (address data, outgoing history, incoming history, transmitting history, receiving history). Furthermore, the mobile phone apparatus selectively displays the transmission destination information making up of the transmission destination information database, and can perform transmission based on the transmission destination information. An operator (26) accepts a selecting operation of the transmission destination information, and accepts a transmitting operation to a transmission destination indicated by the selected transmission destination information. A determiner (24, S61, S97, S320, S420, S620) determines whether or not transmission destination information in relation to the selected transmission destination information (similar address, adjacent transmission destination information) is included in the transmission destination information database when the operator accepts the transmitting operation based on the selected transmission destination information. A displayer (24, S63, S99, S360, S510, S680) displays confirmation information when the determiner determines that the transmission destination information in relation to the selected transmission destination information is included.

According to the first invention, when a transmitting operation is performed, the confirmation information is displayed, capable of reducing an erroneous transmission.

A second invention is according to the first invention, wherein the transmission destination information includes a family name portion as information of a part of a family name and a first name, and the determiner determines whether or not transmission destination information having the family name portion the same as or similar to the family name portion included in the selected transmission destination information is included in the transmission destination information database when the operator accepts the transmitting operation based on the selected transmission destination information, and the displayer displays the confirmation information when the determiner determines that the transmission destination information having the same or similar family name portion is included.

In the second invention, in the mobile phone apparatus, the address book data (1040) being made up of address data in which a surname (family name portion), and a phone number and a mail address are brought into correspondence with each other is stored. The operator is a key input device, for example, and accepts a selecting operation of the transmission destination information, and accepts a transmitting operation to a transmission destination indicated by the selected transmission destination information. The determiner (24, S61, S97), when a transmitting operation based on the transmission destination information including the family name of “YAMADA”, for example is accepted, determines whether or not another transmission destination information (similar address) having the family name portion of “YAMADA” is included in the transmission destination information database. The displayer (24, S63, S99) displays confirmation information if another transmission destination information having the family name portion of “YAMADA” is included in the transmission destination information database.

According to the second invention, when a transmitting operation is performed, another transmission destination information being different from the selected transmission destination information, and having the same or similar family name portion is displayed, capable of reducing an erroneous transmission.

A third invention is according to the second invention, further comprising: a storage which stores a erroneous transmission preventive database being made up of at least two or more transmission destination information having the same or similar family name portion, wherein the determiner determines whether or not the transmission destination information having the family name portion the same as or similar to the family name portion included in the selected transmission destination information is included on the basis of the erroneous transmission preventive database.

In the third invention, a storage (34) stores an erroneous transmission preventive database being made up of two transmission destination information having the family name portion of “YAMADA”, for example. The determiner determines whether or not the transmission destination information having the family name portion the same as or similar to the family name portion included in the selected transmission destination information is included on the basis of the erroneous transmission preventive database.

According to the third invention, the determination based on the erroneous transmission preventive database makes it possible to shorten a processing time until the confirmation information is displayed.

A fourth invention is according to the third invention, wherein the operator further accepts a registering operation of new transmission destination information with respect to the transmission destination information database, further comprising: an extractor which extracts a family name portion from the new transmission destination information; and a register which, when there is the transmission destination information including the family name portion the same as or similar to the family name portion extracted by the extractor, registers the transmission destination information and the new transmission destination information in the erroneous transmission preventive database.

In the fourth invention, when a registering operation is performed on the operator, new transmission destination information is registered in the transmission destination information database. An extractor (24, S11), if the family name and the first name included in the new transmission destination information is “YAMADA #ROU”, extracts “YAMADA” as a family name portion. The register (24, S17), if the transmission destination information of “YAMADA *ROU” is included in the transmission destination information database, the transmission destination information of “YAMADA *ROU” and “YAMADA #ROU” are registered in the erroneous transmission preventive database.

According to the fourth invention, only when there is the transmission destination information having the same or similar family name portion, they are registered in the erroneous transmission preventive database, capable of reducing an amount of data in the erroneous transmission preventive database.

A fifth invention is according to the fourth invention, wherein the transmission destination information further includes a first name portion, and the extractor includes a character extractor which extracts the family name portion on the basis of input information input between the family name portion and the first name portion.

In the fifth invention, in the transmission destination information, a first name portion of “#rou”, etc. is further included. A character extractor (24, S33) includes a character extractor which extracts the family name portion on the basis of input information (comma, center dot, etc.) input between the family name portion and the first name portion.

According to the fifth invention, by using the input information that allows for an easy input, the family name portion can be easily extracted.

A sixth invention is according to the fourth invention, wherein the operator further accepts a character input operation and a character deciding operation, and the extractor includes a deciding operation extractor which extracts the family name portion in response to a first character deciding operation when the family name portion is input.

In the sixth invention, the operator further accepts a character input operation and a character deciding operation by a user, for example. A deciding operation extractor (24, S123), when a character string of “Yamada”, for example is input, and converted into a character string of “YAMADA”, and then a character deciding operation is performed, extracts the character string of “YAMADA” as a family name portion.

According to the sixth invention, when the family name portion is decided, the family name portion is extracted according to a character deciding operation by the user, allowing the user to unconsciously extract the family name portion.

A seventh invention is according to the fourth invention, wherein the operator further accepts an extracting operation of the family name portion, and the extractor further includes an extracting operation extractor, when the operator accepts an extracting operation, extracts the family name portion in response to the extracting operation.

In the seventh invention, the operator accepts an extracting operation of designating the range to be extracted of the family name portion. Then, an operation extractor (24, S145) extracts the character string included in the range as a family name portion when the range to be extracted is designated.

According to the seventh invention, by making it possible to manually extract the family name portion, the family name portion can accurately be extracted.

An eighth invention is according to the first invention, further comprising: a changer which accepts an operation of changing the transmission destination information after the displayer displays the confirmation information.

In the eighth invention, a changer (24, S69, S105), in a case that “YAMADA #ROU” is an arbitrary transmission destination information, can change it to the transmission destination information of “YAMADA *ROU” being a similar transmission destination information after the display of the confirmation information is displayed.

According to the eighth invention, the selected transmission destination information is made changeable to the similar transmission destination information, and whereby, it becomes possible to easily modify the result due to an erroneous operation.

A ninth invention is according to the second invention, wherein a flag indicating that it has the same or similar family name portion is given to each of at least two or more transmission destination information having the same or similar family name portion in the transmission destination information database, and the determiner determines whether or not the transmission destination information having the family name portion the same as or similar to the family name portion included in the selected transmission destination information is included in the transmission destination information database on the basis of the flag given to the transmission destination information in the transmission destination information database.

In the ninth invention, a flag (Y) is given to the transmission destination information of “YAMADA #ROU” and “YAMADA *ROU” in the transmission destination information database, for example. Furthermore, the determiner, when a transmitting operation based on the selected transmission destination information is accepted, makes the determination on the basis of the “YAMADA #ROU” and the “YAMADA *ROU” to which the flag of the transmission destination information is given.

According to the ninth invention, without creating the erroneous transmission preventive database, an erroneous transmission can be prevented, capable of saving a data capacity.

A tenth invention is according to the first invention, wherein the transmission destination information further includes a phone number, and the transmitting operation includes a voice transmitting operation.

In the tenth invention, the mobile phone apparatus executes a voice transmitting processing on the basis of the transmission destination information including a partner's phone number, for example.

An eleventh invention is according to the first invention, wherein the transmission destination information further includes a mail address, and the transmitting operation includes a mail sending operation.

In the eleventh invention, the mobile phone apparatus executes an e-mail transmitting processing on the basis of the transmission destination information including a partner's mail address, for example.

According to the tenth invention and the eleventh invention, if the transmitting operation is based on the transmission destination information, it is possible to conform to a transmitting operation such as an SMS (Short Message Service), etc. without being restricted to the voice transmission and the e-mail transmission (referred to as e-mail sending).

A twelfth invention is according to the second invention, wherein the confirmation information is information including the family name and the first name indicated by at least the selected transmission destination information.

In the twelfth invention, when a transmitting operation is performed on the basis of the transmission destination information of “YAMADA *ROU”, for example, the character string indicating the family name and the first name of “YAMADA #ROU” is displayed as confirmation information.

According to the twelfth invention, the family name and the first name of the partner indicated by the transmission destination information are included in the confirmation information, and therefore, it is easily notice an erroneous transmission.

A thirteenth invention is according to the first invention, wherein transmission destination information in relation to the selected transmission destination information is transmission destination information displayed to be adjacent to the selected transmission destination information, and further comprising; a changing operation acceptor which accepts an operation of changing the selected transmission destination information when the displayer displays the confirmation information; an adjacent transmission destination information displayer which displays the transmission destination information displayed to be adjacent to the selected transmission destination information when there is an operation of changing the selected transmission destination information; a selecting operation acceptor which accepts an operation of selecting the transmission destination information displayed to be adjacent; a deciding operation acceptor which accepts an operation of deciding the accepted transmission destination information as a transmission destination; and a transmitter which performs a transmission to the accepted transmission destination information.

A fourteenth invention is according to the thirteenth invention, wherein the transmission destination information database includes at least one of an address book, a telephone incoming history, a telephone outgoing history, a mail receiving history, and a mail transmitting history.

A fifteenth invention is according to the thirteenth invention, wherein the transmission destination information displayed to be adjacent is transmission destination information that is displayed above and/or below the decided transmission destination information.

A sixteenth invention is according to the thirteenth invention, wherein the transmission destination information displayed to be adjacent is transmission destination information that is displayed above and/or below, right and/or left, diagonally upward right and/or diagonally downward left, and diagonally upward left and/or diagonally downward right.

A seventeenth invention is a mobile phone apparatus having a transmission destination information database being made up of transmission destination information including a family name portion as information of a part of a family name and a first name, selectively displaying the transmission destination information making up of the transmission destination information database, and capable of transmitting based on the transmission destination information, comprising: an operator which accepts a selecting operation of the transmission destination information, and accepts a transmitting operation to a transmission destination indicated by the selected transmission destination information; a determine which determines whether or not transmission destination information having a family name portion the same as or similar to the family name portion included in the selected transmission destination information is included in the transmission destination information database when the operator accepts the transmitting operation based on the selected transmission destination information; and a displayer which displays confirmation information when the determiner determines that the transmission destination information having the same or similar family name portion is included.

In the seventeenth invention, in the mobile phone apparatus (10), the address book data (1040) being made up of address data in which a surname (family name portion), and a phone number and a mail address are brought into correspondence with each other is stored. The mobile phone apparatus further selectively displays the transmission destination information making up of the transmission destination information database, and can transmit based on the selected transmission destination information. An operator (26) is a key input device, for example, and accepts a selecting operation of the transmission destination information, and accepts a transmitting operation to a transmission destination indicated by the selected transmission destination information. A determiner (24, S61, S97), when a transmitting operation based on the transmission destination information including the family name of “YAMADA”, for example, is accepted, determines whether or not another transmission destination information (similar address) having the family name portion of “YAMADA” is included in the transmission destination information database. A displayer (24, S63, S99) displays confirmation information if another transmission destination information (similar address) having the family name portion of “YAMADA” is included in the transmission destination information database.

According to the seventeenth invention, when a transmitting operation is performed, another transmission destination information being different from the selected transmission destination information, but having the same or similar family name portion is displayed, capable of reducing an erroneous transmission.

An eighteenth invention is a confirmation information displaying method of a mobile phone apparatus (10) having a transmission destination information database (address book data 1040) being made up of transmission destination information (address data) including a family name portion as information of a part of a family name and a first name and an operator (26) which accepts a selecting operation of the transmission destination information, and accepts a transmitting operation to a transmission destination indicated by the selected transmission destination information, selectively displaying the transmission destination information making up of the transmission destination information database, and capable of transmitting based on the transmission destination information, including following steps of determining (S61, S97) whether or not transmission destination information having the family name portion the same as or similar to the family name portion included in the selected transmission destination information is included in the transmission destination information database when the operator accepts the transmitting operation based on the selected transmission destination information; and displaying (S63, S99) confirmation information when it is determined that the transmission destination information having the same or similar family name portion is included.

In the eighteenth invention, similar to the seventeenth invention, when a transmitting operation is performed, another transmission destination information being different from the selected transmission destination information, but having the same or similar family name portion is displayed, capable of reducing an erroneous transmission.

A nineteenth invention is a mobile phone apparatus, comprising: a displayer which displays a plurality of transmission destination information; a first selecting operation acceptor which accepts an operation of selecting one of the displayed transmission destination information; a first deciding operation acceptor which accepts an operation of deciding the accepted transmission destination information as a transmission destination; a confirmation displayer which displays a confirmation screen of the decided transmission destination information; a changing operation acceptor which accepts an operation of changing the decided transmission destination information; an adjacent transmission destination information displayer which displays transmission destination information displayed to be adjacent to the decided transmission destination information when there is an operation of changing the decided transmission destination information; a second selecting operation acceptor which accepts an operation of selecting the transmission destination information displayed to be adjacent thereto; a second deciding operation acceptor which accepts an operation of deciding the accepted transmission destination information as a transmission destination; and a transmitter which performs a transmission to the accepted transmission destination information.

A twentieth invention is a transmitting method of a mobile phone apparatus, including steps of: accepting an operation of selecting one of transmission destination information; accepting an operation of deciding the accepted transmission destination information as a transmission destination; displaying a confirmation screen of the decided transmission destination information; accepting an operation of changing the decided transmission destination information; displaying transmission destination information displayed to be adjacent to the decided transmission destination information when there is an operation of changing the decided transmission destination information; accepting an operation of selecting the transmission destination information displayed to be adjacent; accepting an operation of deciding the accepted transmission destination information as a transmission destination; and performing a transmission to the accepted transmission destination information.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an electric configuration of a mobile phone apparatus of one embodiment of the present invention;

FIG. 2 is an external view showing one example of an appearance of the mobile phone apparatus shown in FIG. 1;

FIG. 3 is an illustrative view showing one example of GUIs to be displayed on display shown in FIG. 1;

FIG. 4 is an illustrative view showing address book data stored in a RAM (RANDOM ACCESS MEMORY) of FIG. 1;

FIG. 5 is an illustrative view showing a procedure before address data is registered in an erroneous transmission preventive database (DB) of the RAM shown in FIG. 1;

FIG. 6 is an illustrative view showing another example of GUIs displayed on the display shown in FIG. 1;

FIG. 7 is an illustrative view showing one example of a memory map of the RAM shown in FIG. 1;

FIG. 8 is a flowchart showing new address creating processing by a processor shown in FIG. 1;

FIG. 9 is a flowchart showing family name portion extracting processing by the processor shown in FIG. 1;

FIG. 10 is a flowchart showing mail creating and sending processing by the processor shown in FIG. 1;

FIG. 11 is a flowchart showing voice transmitting processing by the processor shown in FIG. 1;

FIG. 12 is a flowchart showing name inputting processing by the processor shown in FIG. 1;

FIG. 13 is a flowchart showing another family name portion extracting processing by the processor shown in FIG. 1;

FIG. 14 is an illustrative view showing another example of address book data stored in the RAM shown in FIG. 1;

FIG. 15 is an external perspective view of a mobile phone apparatus showing one example of a second embodiment;

FIG. 16 is a system chart of the mobile phone apparatus 100;

FIG. 17 is a memory map of the mobile phone apparatus;

FIG. 18 is a flowchart showing mail sending processing;

FIG. 19 is a flowchart showing telephone transmitting processing;

FIG. 20 is a flowchart showing transmission destination information selecting processing 1 being one embodiment;

FIG. 21 is an illustrative view showing one example of a screen display for selecting a transmission destination and a mail sending destination from an incoming history;

FIG. 22 is an illustrative view showing one example of a confirmation information displaying screen;

FIG. 23 is a flowchart showing transmission destination information selecting processing 2 being another embodiment;

FIG. 24 is one example of a screen display for selecting transmission destination information from an outgoing history;

FIG. 25 is an illustrative view showing one example of a confirmation information displaying screen;

FIG. 26 is a flowchart showing transmission destination information selecting processing 3 being still another embodiment;

FIG. 27 is one example of a screen from which transmission destination information is selected from a list of names sorted in the order of Japanese syllabary; and

FIG. 28 is an illustrative view showing one example of a confirmation information displaying screen.

### DETAILED DESCRIPTION OF THE PREFERRED EMBODIMENTS

### First Embodiment

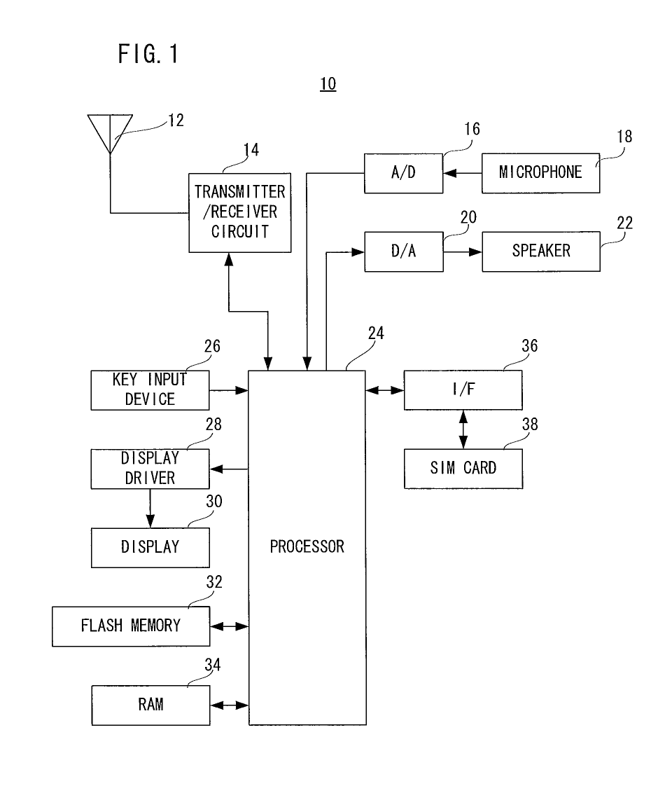

Referring to FIG. 1, a mobile phone apparatus 10 of this embodiment includes a processor 24 that is called a CPU or a computer. The processor 24 is connected with a transmitter/receiver circuit 14, an A/D 16, a D/A 20, a key input device 26, a display driver 28, a flash memory 32, a RAM (RANDOM ACCESS MEMORY) 34 and an I/F 36. Furthermore, the transmitter/receiver circuit 14 is connected with an antenna 12, the A/D 16 is connected with a microphone 18, and the D/A 20 is connected with a speaker 22 via an amplifier (not illustrated). In addition, the display driver 28 is connected with a display 30, and the I/F 36 is connected with an SIM (Subscriber Identity Module) card 38.

The processor 24 entirely controls the mobile phone apparatus 10. The RAM 34 being a storage is utilized as a work area (including depicting area) or a buffer area of the processor 24. In the flash memory 32, content data such as characters, images, sounds and video images of the mobile phone apparatus 10 are recorded.

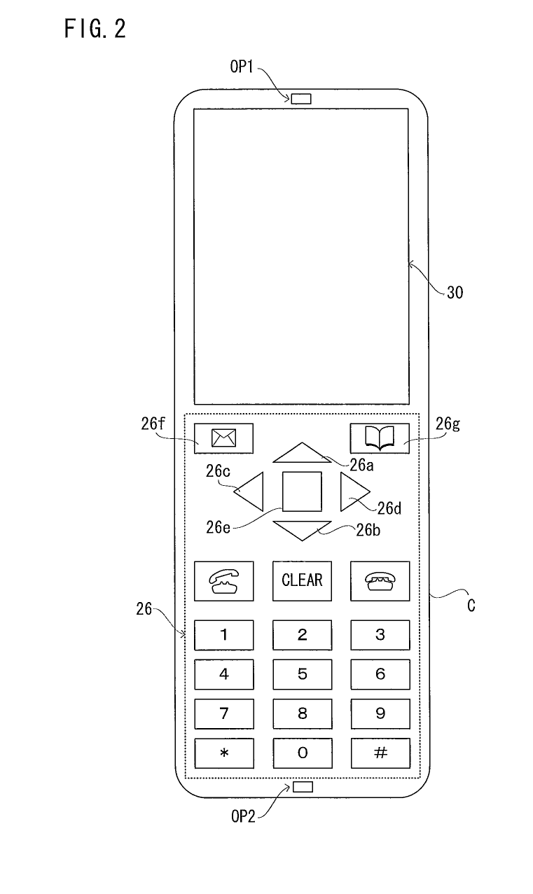

The key input device 26 is also called an operator, and has a dial key (see FIG. 2) including “0” to “9” keys, a “*” key and a “#” key, and other keys, with which the key information (key data) operated by the user is input to the processor 24. The display driver 28 controls the display of the display 30 connected to the display driver 28 under the control of the processor 24.

The A/D 16 converts an analog sound signal as to a voice or sound input through the microphone 18 connected to the A/D 16 into a digital sound signal. The D/A 20 converts (decodes) a digital sound signal into an analog sound signal, and applies the analog signal to the speaker 22 via the amplifier. Thus, the voice or the sound corresponding to the analog sound signal is output from the speaker 22.

The transmitter/receiver circuit 14 is a circuit for performing a wireless communication in a CDMA system, for example. For example, when the user instructs the transmitter/receiver circuit 14 to transmit a voice by utilizing the key input device 26, the transmitter/receiver circuit 14 executes voice transmitting processing under the control of the processor 24 to thereby output a voice transmitting signal via the antenna 12. The voice transmitting signal is transmitted to a telephone of a communication partner through base stations and communication networks (not illustrated). Then, when incoming call processing is performed by the telephone of the communication partner, a connected state (communication allowable state) is established, and then, the processor 24 executes conversation processing.

Describing normal conversation processing in detail, a modulated audio signal (high frequency signal) transmitted from the telephone of the communication partner is received by the antenna 12. The received modulated audio signal undergoes demodulation processing and decoding processing by the transmitter/receiver circuit 14. The received voice signal acquired by such the processing is converted into an analog sound signal by the D/A 20, and then, the converted analog signal is output from the speaker 22. On the other hand, a voice signal to be transmitted captured through the microphone 18 is converted into a digital sound signal by the A/D 16, and then, the converted digital signal is applied to the processor 24. The converted digital signal undergoes encoding processing and modulation processing by the transmitter/receiver circuit 14 under the control of the processor 24, and is output via the antenna 12. Thus, the modulated audio signal is transmitted to the telephone of the communication partner via the base stations and the communication networks.

Furthermore, when a voice transmitting signal from the telephone of the communication partner is received by the antenna 12, the transmitter/receiver circuit 14 notifies the processor 24 of a voice incoming (also referred to as “call in”). In response thereto, the processor 24 controls the display driver 28 to display calling source information (phone number) described in the incoming call notification on the display 30. At about the same time, the processor 24 outputs an incoming call tone (or, incoming call melody, incoming call sound) from an incoming call notifying speaker (not illustrated), and vibrates the mobile phone apparatus 10 by further driving (rotating) a motor not shown. When the user performs an answer operation by utilizing key input device 26, the transmitter/receiver circuit 14 executes a voice incoming call processing to establish a connected state (communication allowable state) under the control of the processor 24, and then, the processor 24 executes the above-described normal conversation processing.

Here, the processor 24 outputs an incoming call tone, and may flash an LED not illustrated. Furthermore, the display 30 may be called a display device. In addition, the antenna 12 receiving a calling signal and calling source information functions as a receiver.

The I/F 36 is an interface for reading address book data (transmission destination information database), profile data and a phone number that are stored in an SIM card 38, etc. Furthermore, the I/F 36 is also an interface for, when the address book data is updated, writing the update result in the SIM card 38.

Additionally, the mobile phone apparatus 10 executes an electronic mail function by using a network not shown. For example, the mobile phone apparatus 10 performs data communications with an e-mail server not shown, and performs transmission and reception of electronic mail.

FIG. 2 is an external view of the mobile phone apparatus 10. Referring to FIG. 2, the mobile phone apparatus 10 has a straight shape, and has a planar rectangular case C. The microphone 18 not shown is contained in the case C, and an opening OP2 passing through the contained microphone 18 is provided at one end of the longitudinal direction of the case C on one main surface. Similarly, the speaker 22 not shown is contained in the case C, and an opening OP1 passing though the contained speaker 22 is provided at the other end of the longitudinal direction of the case C on the one main surface.

The key input device 26 includes an upward key 26a, a downward key 26b, a leftward key 26c and a rightward key 26d other than the dial key, and also includes a decide key 26e, a mail key 26f and an address book key 26g. The respective keys are provided on the main surface of the case C. Here, the upward key 26a, the downward key 26b, the leftward key 26c and the rightward key 26d may collectively be called a cursor key. In addition, the key input device 26 includes a talk key, a talk end key, etc., and these keys are also provided on the main surface of the case C. Furthermore, the display 30 is attached such that the monitor screen is exposed from the main surface of the case C.

For example, while confirming the display 30, the user inputs a phone number by operating the dial key, and performs a voice transmitting operation by the talk key, and performs a conversation end operation by the talk end key. Furthermore, the user displays a GUI corresponding to an e-mail function by operating the mail key 26f, and displays a GUI for browsing the address book data by operating the address book key 26g. In addition, the user performs a selection and a decision of the GUI menu by operating the cursor key and the decide key 26e. Then, the user turns on/off the power of the mobile phone apparatus 10 by long-pushing the talk end key.

Here, the antenna 12, the transmitter/receiver circuit 14, the A/D 16, the D/A 20, the processor 24, the display driver 28, the flash memory 32, the RAM 34, the I/F 36 and the SIM card 38 are contained in the case C, and not illustrated in FIG. 2.

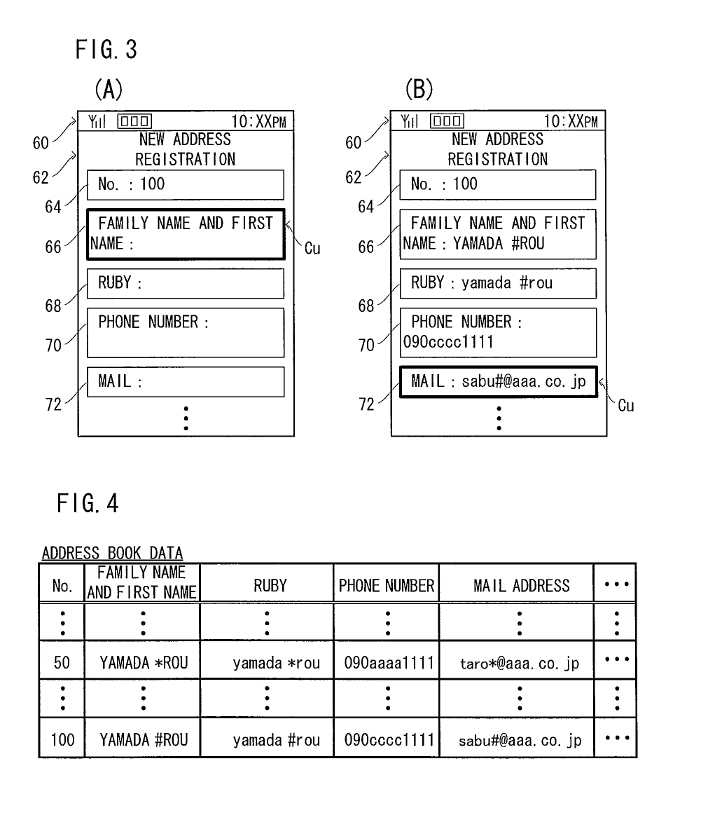

Each of FIG. 3(A) and FIG. 3 (B) is an illustrative view showing a GUI displayed on the display 30. Referring to FIG. 3(A), the display 30 is made up of a state displaying area 60 and a function displaying area 62. In the state displaying area 60, icons representing an electromagnetic wave receiving state by the antenna 12, and a remaining amount of the battery of the secondary battery (referred to as a “PICT”) and a current date and time are displayed. Furthermore, in the function displaying area 62, various images are displayed in correspondence with a function to be executed in the mobile phone apparatus 10, and a GUI for registering a new address is displayed in FIG. 3(A). For example, the GUI for registering a new address is displayed after a new address registering operation is performed in a state that the address book data can be browsed.

Furthermore, the GUI shown in FIG. 3(A) is made up of a No. item 64 for inputting an address number, a family name and first name item 66 for inputting a family name and a first name, a ruby item 68 for inputting a ruby, a telephone item 70 for inputting a phone number, a mail item 72 for inputting a mail address, etc. Then, each item is selected by a cursor Cu that is operable by a cursor key, and can be input by the decide key 26e.

Then, referring to FIG. 3(B), with respect to the address numbers 100, a phone number (090cccc1111) and a mail address (sabu#@aaa.co.jp) of “YAMADA #ROU (yamada#rou)” are input, and when the address book key 26g is pushed, for example, each input item is registered in the address book data as new address data (transmission destination information).

Furthermore, the registered new address data makes up of the address book data as shown in FIG. 4. Referring to FIG. 4, the address book data is made up of columns of No., family name and first name, ruby, phone number and mail address, etc. Furthermore, in the column of the No., an address number of each address data is recorded. Thus, with respect to the line for which “100” is recorded in the column of No., in the column of the family name and first name, “YAMADA #ROU”, in the column of the ruby, “yamada#rou”, in the column of the phone number, “090cccc1111”, and in the column of the mail address, “sabu#@aaa.co.jp”, etc. are recorded in correspondence with the column of No.

In addition, with respect to the line for which “50” is recorded in the column of No., in the column of the family name and first name “YAMADA *ROU”, in the column of the ruby, “yamada*rou”, in the column of the phone number “090aaaa1111”, in the column of the mail address, “taro*@aaa.co.jp”, etc. are recorded in correspondence with the column of No.

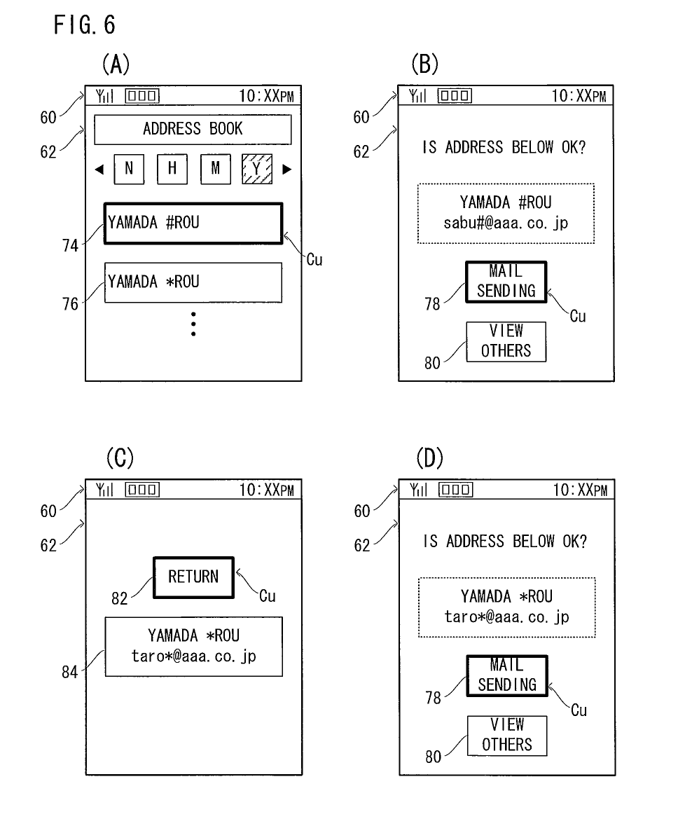

For example, if the address book data is sorted in the order of the Japanese syllabary, and then displayed, “YAMADA #ROU” and “YAMADA *ROU” are the same in the family name portion (Yamada), and therefore, two address data are continuously displayed (see FIG. 6(A)). Here, in this embodiment, like a relationship of the address data of “YAMADA *ROU” to the address data of “YAMADA #ROU” the address data having the same or similar family name portion, etc. is defined as “similar address data”.

Here, in this embodiment, when an operation of a voice transmission or a mail sending (also referred to as a mail transmission) is performed on the basis of the selected address data, if there is similar address data, confirmation information including a character string, an image, optical information, etc. are displayed on the display 30 to thereby prevent an erroneous transmission.

More specifically, every time that a new address is registered in the address book data, the presence or absence of the similar address data is determined. In addition, if there is similar address data, the new address data and the similar address data are redundantly registered, that is, copied in an erroneous transmission preventive database (DB).

Then, when a voice transmitting operation is performed on the basis of the address data arbitrarily selected from the address book data, it is determined whether or not the address data is registered in the erroneous transmission preventive DB, and if it is registered, the confirmation information for preventing the erroneous transmission is displayed.

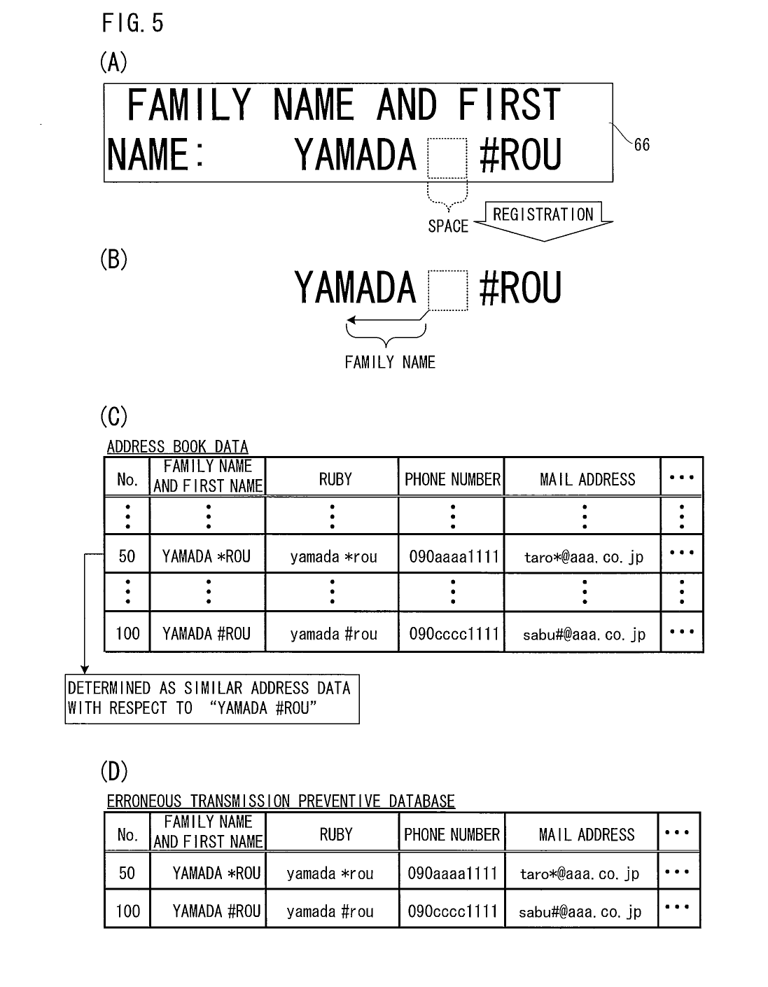

First, processing of redundantly registering an address in the erroneous transmission preventive DB is explained. FIG. 5(A) is an enlarged view of the family name and first name item 66 in FIG. 3(B). Referring to FIG. 5(A), there is a space (specific character) between “YAMADA” and “#ROU”. Furthermore, referring to FIG. 5(B), when a registering operation of a new address is performed in this state, with reference to the space, the former-half portion, that is, “YAMADA” is extracted as a family name portion. In addition, referring to FIG. 5(C), in the column of the family name and first name of the address book data, address data having a family name portion the same as the extracted family name portion, that is, the address data in which the family name portion is divided by the space, and the family name portion is “YAMADA” is searched. The address data of “YAMADA *ROU” having the address number “50” is determined as a similar address with respect to “YAMADA #ROU”. Then, with reference to FIG. 5(D), the address data of “YAMADA #ROU” and “YAMADA *ROU” are redundantly registered in the erroneous transmission preventive DB.

Thus, only when there is the address data having the same or similar family name portion, both of the address data are redundantly registered in the erroneous transmission preventive DB, and whereby, it is possible to reduce an amount of data in the erroneous transmission preventive DB. Furthermore, when the family name portion is extracted, a specific character that can be easily input is used, and therefore, it is possible to easily extract the family name portion. It should be noted that as a specific character, a comma “,”, a center dot “•”, a sharp “#”, a hyphen “-”, an underscore “_” and an apostrophe “'” are included without being restricted to only the space.

Next, processing before confirmation information is displayed is explained. In a case that the user creates new e-mail, and sets a destination on the basis of the address book data, a GUI for selecting address data is displayed on the display 30. Referring to FIG. 6(A), on the display 30, the address data in the “Y” line, that is, an icon 74 corresponding to the address data of “YAMADA #ROU”, an icon 76 corresponding to the address data of “YAMADA *ROU” are displayed, and the cursor Cu for selecting an icon is displayed. Then, when the decide key 26e is operated in a state that the icon of “YAMADA #ROU” 74 is selected by the cursor Cu, the mail address (sabu#@aaa.co.jp) of “YAMADA #ROU” is set to the destination of the newly created e-mail.

When the mail sending processing is performed in this state, a character string of “IS ADDRESS BELOW OK?” and the mail address of “YAMADA #ROU” are displayed as confirmation information as shown in FIG. 6(B). In addition, a consent key 78 in which a character string of “MAIL SENDING” is written, a display key 80 in which a character string of “VIEW OTHERS” and a cursor Cu for selecting these keys are displayed. Here, when the consent key 78 is operated, mail sending processing with respect to “YAMADA #ROU” is executed. On the other hand, when the display key 80 is operated, with reference to FIG. 6(C), a return key 82 for returning to the screen in FIG. 6(B) and a change key 84 in which the mail address of “YAMADA *ROU” being the similar address data is written are displayed. Then, when the change key 84 is operated, with reference to FIG. 6(D), the confirmation information the same as FIG. 6(B) is displayed, and the mail address of the “YAMADA *ROU” is displayed in place of the address data of the “YAMADA #ROU”. That is, the destination of the e-mail is changed from the mail address of “YAMADA #ROU” to the mail address of “YAMADA *ROU”. Then, when the consent key 78 is operated in this state, mail sending processing with respect to the “YAMADA *ROU” is executed. On the other hand, when the return key 82 is operated, the screen returns to the screen shown in FIG. 6(B).

Thus, in a case that there is similar address data in the address data set as a destination, the confirmation information is displayed on the display 30, and the GUI for changing to the similar address data is displayed. Furthermore, by making the selected address data replaceable with the similar address data, an erroneous operation can be easily modified. Moreover, in this embodiment, the determination is made on the basis of the erroneous transmission preventive DB, and therefore, it is possible to shorten the processing time until the confirmation information is displayed. In addition, as described above, the data amount can be reduced, and thus the processing time is especially shortened. Then, in the confirmation information, the family name and first name of the communication partner are included, allowing the user to easily notice the erroneous transmission.

It should be noted that in a case of the voice transmission, when the talk key is pushed in a situation shown in FIG. 6(A), the confirmation information shown in FIG. 6(B) is displayed. Furthermore, in a case of the voice transmission, the mail addresses in FIG. 6(B) to (D) are replaced with the phone numbers.

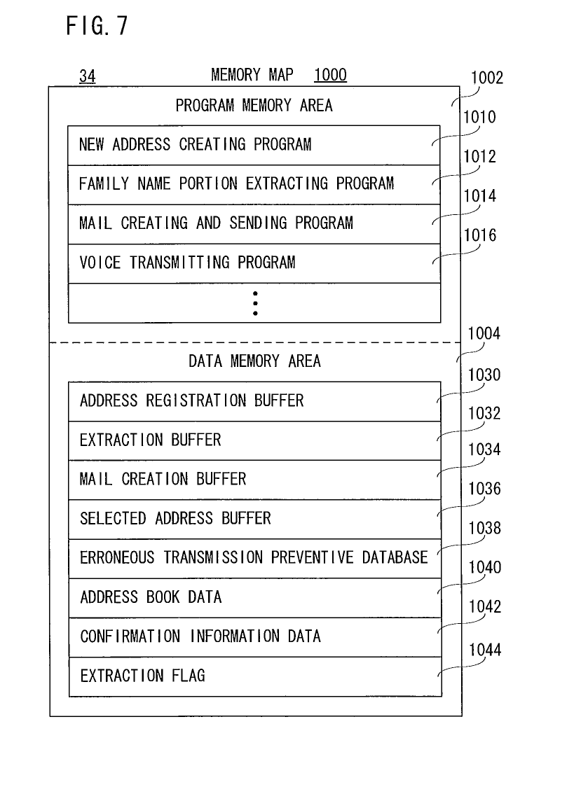

FIG. 7 is an illustrative view showing a memory map 1000 of the RAM 34. In the memory map 1000 of the RAM 34, a program memory area 1002 and a data memory area 1004 are included. Furthermore, a part of the programs and data are read entirely at a time, or partially and sequentially as required from the flash memory 32 to be stored in the RAM 34, and executed by the processor 24. In addition, the address book data is read from the SIM card 38 via the I/F 36, and stored in the RAM 34.

The program memory area 1002 stores a program for operating the mobile phone apparatus 10, and is made up of a new address creating program 1010, a family name portion extracting program 1012, a mail creating and sending program 1014, a voice transmitting program 1016, etc.

The new address creating program 1010 is a program for creating a new address, and registering the same. The family name portion extracting program 1012 is a subroutine of the new address creating program 1010, and is a program for extracting a family name portion from a new address. The mail creating and sending program 1014 is a program for creating and sending a new e-mail. The voice transmitting program 1016 is a program for establishing a voice communication.

It should be noted that although illustration is omitted, in the program for operating the mobile phone apparatus 10, a program for controlling the GUIs to be displayed on the display 30, etc. is included.

In the data memory area 1004, an address registration buffer 1030, an extraction buffer 1032, a mail creation buffer 1034, a selected address buffer 1036, etc. are provided, and an erroneous transmission preventive DB 1038, address book data 1040 and confirmation information data 1042 are stored. In addition, in the data memory area 1004, an extraction flag 1044, etc. is also provided.

The address registration buffer 1030 is a buffer for temporarily storing an input character string in each item when new address data is registered. The extraction buffer 1032 is a buffer for temporarily storing the family name portion extracted by the processing of the family name portion extracting program 1012. The mail creation buffer 1034 is a buffer for temporarily storing data of e-mail that is being created, that is, character strings input as a destination and a mail text. The selected address buffer 1036 is a buffer for temporarily storing the address data that is being selected in a case that the address book data is displayed.

The erroneous transmission preventive DB 1038 is a database constructed under the specification shown in FIG. 5(D), for example, in which a part of the address book data is redundantly registered. The address book data 1040 is the address book data read from the SIM card 38. Here, storing the address book data 1040 in the RAM 34 increases the speed of displaying processing of the address book data. Furthermore, when the new address data is registered, it is registered in the address book data 1040. Then, when the power of the mobile phone apparatus 10 is turned off, the address book data stored in the SIM card 38 is overwritten with the address book data 1040 stored in the RAM 34.

The confirmation information data 1042 is data made up of a character string, such as “IS ADDRESS BELOW OK?”, as shown in FIG. 6(B), for example, read by the processor 24, and are displayed on the display 30 when there is a similar address at a time of the transmission.

The extraction flag 1044 is a flag for determining whether or not a family name portion can be extracted. For example, the extraction flag 1044 is constructed of one bit register. Furthermore, when the extraction flag 1044 is turned on (established), a data value “1” is set to the register. On the other hand, when the extraction flag 1044 is turned off (unestablished), a data value “0” is set to the register. Furthermore, the extraction flag 1044 is turned off in the initial state.

Although illustration is omitted, in the data memory area 1004, a counter and a flag that are required for an operation of the mobile phone apparatus 10 are also provided as well as the image data, etc. to be displayed on the display 30 is stored.

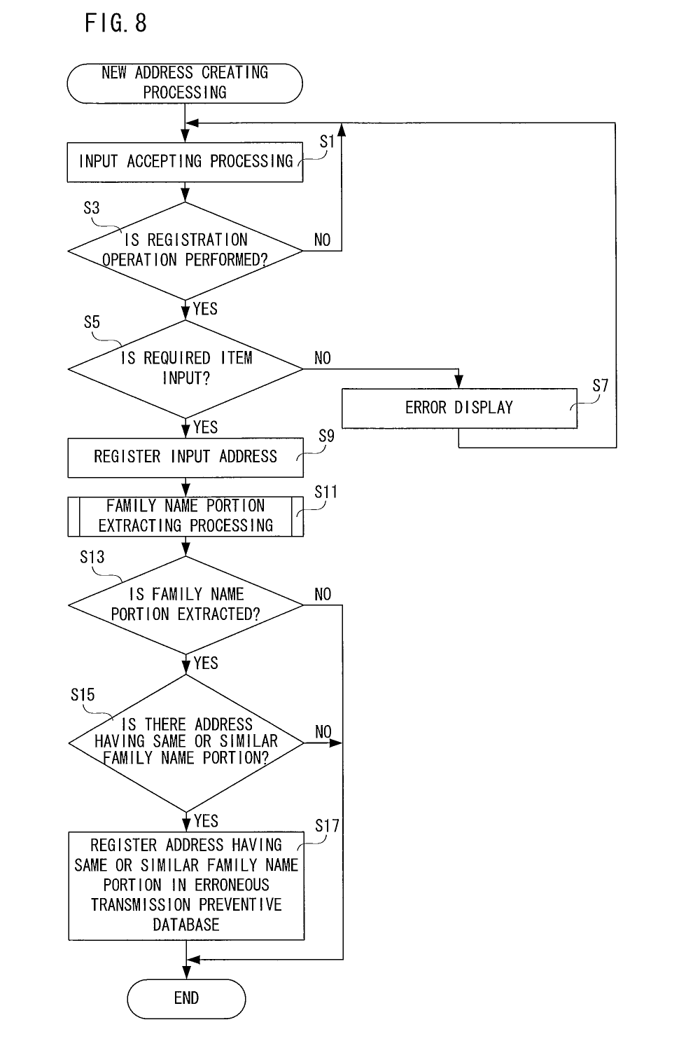

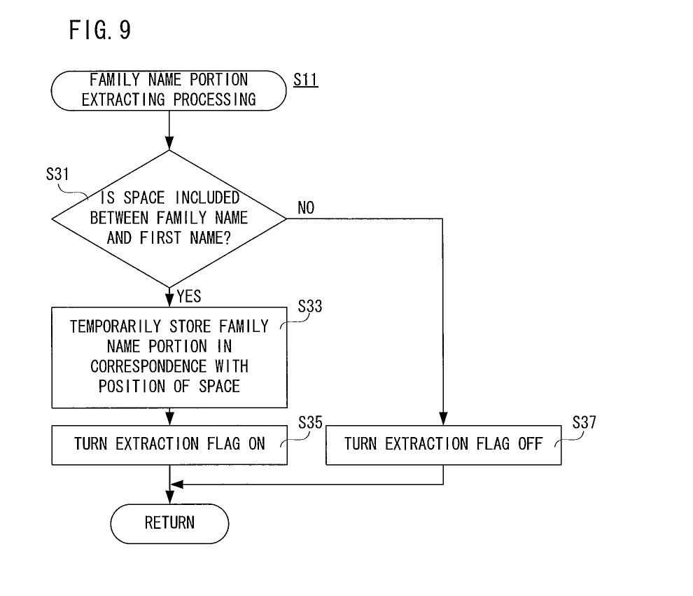

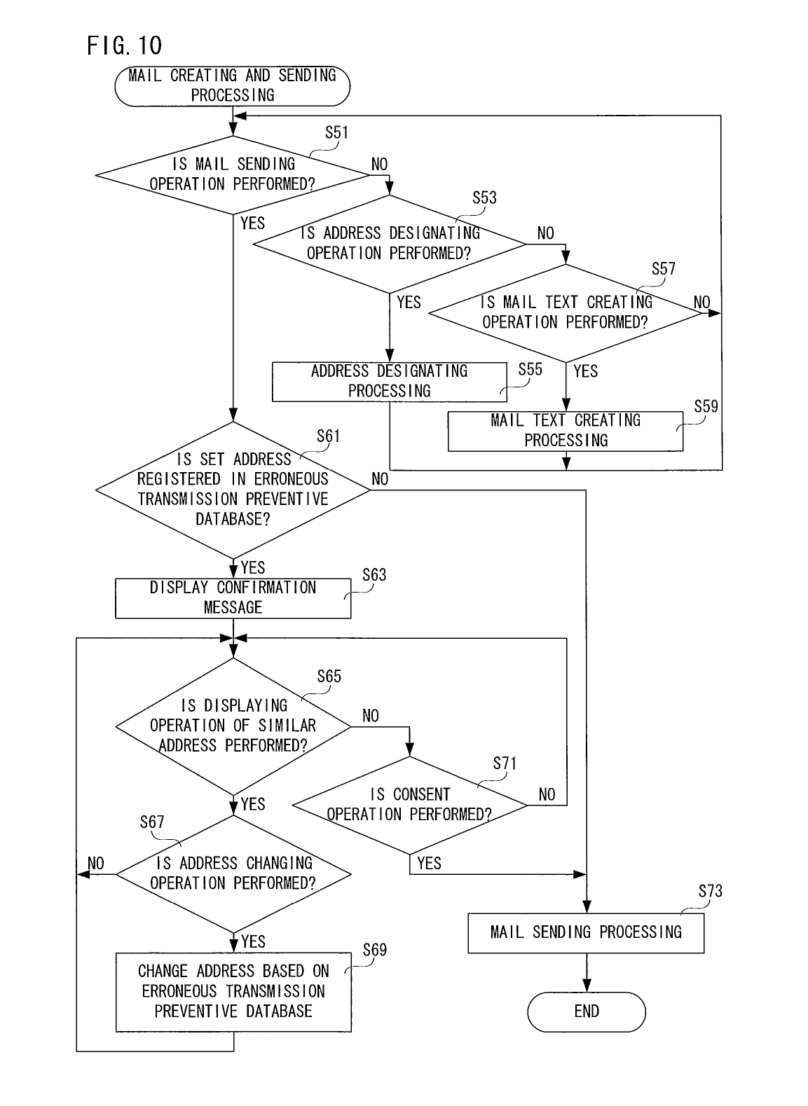

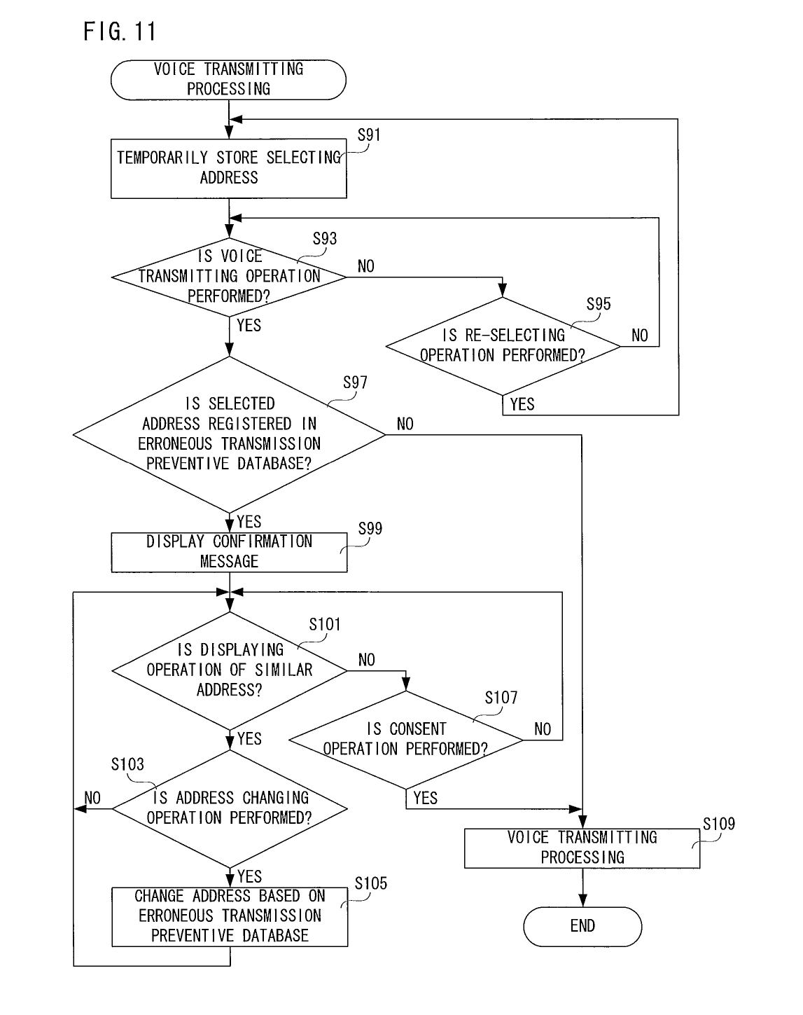

The processor 24 performs a plurality of tasks in parallel including new address creating processing shown in FIG. 8, family name portion extracting processing shown in FIG. 9, mail creating and sending processing shown in FIG. 10, voice transmitting processing shown in FIG. 11, etc. under the control of the RTOS (Real-time Operating System), such as “Android (registered trademark)”, “Linux (registered trademark)” and “REX”.

FIG. 8 is a flowchart showing the new address creating processing. For example, when the user performs a new address data registration starting operation, the processor 24 executes input accepting processing in a step S1. That is, in response to a key operation performed on the key input device 26, each item shown in FIG. 3(A) can be input. Successively, in a step S3, it is determined whether or not a registering operation is performed. For example, it is determined whether or not the address book key 26g is pushed as a registering operation. If “NO” in the step S3, that is, if a registering operation is not performed, the input accepting processing in the step Si is successively executed. On the other hand, if “YES” in the step S3, that is, if a registering operation is performed, it is determined whether or not a required item is input in a step S5. The required item is a family name and first name and a phone number, or a family name and first name and a mail address. Thus, in the step S5, it is determined whether or not a character string is input in the family name and first name item 66 and the telephone item 70, or in the family name and first name item 66 and the mail item 72. More specifically, in the step S5, the processor 24 determines whether or not character strings of the family name and the first name and the phone number, or character strings of the family name and the first name and the mail address are stored in the address registration buffer 1030.

If “NO” in the step S5, that is, if the family name and first name and the phone number are not input, an error display is performed in a step S7, and the process returns to the step S1. For example, in the step S7, an alarm message that the “REQUIRED ITEM IS NOT INPUT, AND THUS, REGISTRATION IS IMPOSSIBLE”, etc. is displayed on the display 30. Alternatively, if “YES” in the step S5, that is, if the family name and first name and the phone number are input, the input address is registered in a step S9. For example, if a registering operation is performed in a state shown in FIG. 3(B), “YAMADA #ROU”, “yamada#rou”, “090cccc1111” and “sabu#@aaa.co.jp” that are stored in the address registration buffer 1030 are regarded as new address data, and registered in the address book data 1040 shown in FIG. 4.

Succeedingly, in a step S11, the family name portion extracting processing is executed. Here, the family name portion extracting processing is described later, and therefore, a detailed description thereof is omitted. Furthermore, the processor 24 executing the processing in the step S11 functions as an extractor.

Successively, in a step S13, it is determined whether or not a family name portion is extracted. That is, it is determined whether or not the family name portion flag 1044 is turned on in accordance with the execution of the family name portion extracting processing. If “NO” in the step S13, that is, if the family name portion is not extracted, and the family name portion flag 1044 is turned off, the new address creating processing is ended.

On the other hand, if “YES” in the step S13, that is, if the family name portion is extracted, and the family name portion flag 1044 is turned on, it is determined whether or not there is an address having the same or similar family name portion in a step S15. For example, in a case that the extracted family name portion is “YAMADA”, in the column of the family name and first name of the address book data 1040, the address data having the family name portion of “YAMADA” is searched. Furthermore, at a time of the search in the step S15 as well, the family name portion is determined on the basis of the space between the family name portion and the first name portion. Then, it is determined whether or not the family name portion determined based on the space and the extracted family name portion are the same as or similar to each other.

If “NO” in the step S15, that is, if the address data having the family name portion of “YAMADA” is not contained in the address book data 1040, the new address creating processing is ended. On the other hand, if “YES” in the step S15, that is, if there is the address data of “YAMADA *ROU” having the family name portion of “YAMADA” as shown in FIG. 5(C), the address having the same or similar family name portion is registered in the erroneous transmission preventive DB in a step S17, and the new address creating processing is ended. For example, in the step S17, as shown in FIG. 5(D), the newly registered address data of “YAMADA #ROU” and the address data of “YAMADA *ROU” having the family name the same as or similar thereto are registered in the erroneous transmission preventive DB 1038. That is, the address data of “YAMADA #ROU” and “YAMADA *ROU” are redundantly registered in the erroneous transmission preventive DB 1038 and the address book data 1040. Here, the processor 24 executing the processing in the step S17 functions as a register.

FIG. 9 is a flowchart showing the family name portion extracting processing executed in the step S11 shown in FIG. 8. When the processing in the step S11 is executed by the processor 24, it is determined whether or not there is a space between the family name and the first name in a step S31. That is, it is determined whether or not a character of space is included in the character string input by the family name and first name item 66. If “NO” in the step S31, that is, if there is no space in the character string input in the family name and first name item 66, the process proceeds to a step S37. On the other hand, if “YES” in the step S31, that is, if there is a space in the character string input in the family name and first name item 66, the family name portion extracted in correspondence with the position of the space is temporarily stored in a step S33. For example, referring to FIG. 5(B), in a case that “YAMADA #ROU” is input in the family name and first name item 66, the character string before the space between “DA” and “#”, that is, “YAMADA” is extracted as a family name portion. Then, the extracted character string of “YAMADA” is temporarily stored in the extraction buffer 1032.

Succeedingly, in a step S35, the extraction flag 1044 is turned on, the family name portion extracting processing is ended, and then, the process returns to the new address creating processing. That is, the character string of the family name portion is temporarily stored in the processing in the step S33, and thus, the extraction flag 1044 is turned on in the step S35.

Here, in a case that it is determined that a space is not included in the family name and first name in the step S31, the extraction flag 1044 is turned off in the step S37. That is, the family name portion is not temporarily stored, and thus, the extraction flag 1044 is turned off.

FIG. 10 is a flowchart showing the mail creating and sending processing. For example, when the user performs an operation of creating a new e-mail, it is determined whether a mail sending operation or not in a step S51. That is, it is determined whether or not a mail sending operation is performed on the key input device 26. If “NO” in the step S51, that is, if a mail sending operation is not performed, it is determined whether an address designating operation or not in a step S53. That is, it is determined whether or not an address designating operation is performed on the key input device 26.

If “YES” in the step S53, that is, if an address designating operation is performed, an address designating processing is executed in a step S55. For example, in the address designating processing, the icons 74, 76 corresponding to the plurality of address data and the cursor Cu are displayed as shown in FIG. 6(A). Then, when the decide key 26e is pushed in a state that an address is selected, the address data corresponding to the icon selected by the cursor Cu is temporarily stored in the mail creation buffer 1034. Then, when such the process is ended, the address designating processing is also ended in the step S55, and therefore, the process returns to the step S51.

Alternatively, If “NO” in the step S53, that is, if the address designating operation is not performed, it is determined whether a mail text creating operation or not in a step S57. That is, in the step S57, it is determined whether or not a mail text creating operation is performed on the key input device 26. If “NO” in the step S57, that is, if the mail text creating operation is not performed, the process returns to the step S51. On the other hand, if “YES” in the step S57, that is, if a mail text creating operation is performed, the mail text creating processing is executed in a step S59, and the process returns to the step S51. That is, in the step S59, the processing of creating the text of the e-mail is executed. Here, if the user makes no input with the mail creating screen displayed, the processing in the steps S51, S53, S57 are repeatedly executed.

Moreover, if “YES” in the step S51, that is, if a mail sending operation is performed, it is determined whether or not the set address is registered in the erroneous transmission preventive DB 1038 in a step S61. If the address data of “YAMADA #ROU” is arbitrarily selected and set as a destination, it is determined whether or not the address data of “YAMADA #ROU” is registered in the erroneous transmission preventive DB 1038. If “NO” in the step S61, that is, if the address data of “YAMADA #ROU” is not registered in the erroneous transmission preventive DB 1038, the process proceeds to a step S73. On the other hand, if “YES” in the step S61, that is, if the address data of “YAMADA #ROU” is registered in the erroneous transmission preventive DB 1038, confirmation information is displayed in a step S63. That is, the processor 24 reads the confirmation information data 1042, and displays the data to thereby display the confirmation information on the display 30 as shown in FIG. 6(B).

Successively, in a step S65, it is determined whether a display operation of a similar address or not. For example, it is determined whether or not the display key 80 shown in FIG. 6(B) is selected by the cursor Cu, and then, the decide key 26e is operated. If “YES” in the step S65, that is, if the decide key 26e is pushed in a state that the display key 80 is selected, it is determined whether or not an address changing operation is performed in a step S67. Here, in a case that the decide key 26e is pushed in a state that the processing in the step S65 is executed, a switch to the display shown in FIG. 6(C) is made. Furthermore, the character string displayed in the change key 84 is displayed on the basis of the similar address data read from the erroneous transmission preventive DB 1038.

For example, in the step S67, it is determined whether or not the change key 84 shown in FIG. 6(C) is selected by the cursor Cu, and then the decide key 26e is operated. If “YES” in the step S67, that is, if the decide key 26e is pushed in a state that the change key 84 is selected, the address is changed on the basis of the erroneous transmission preventive DB 1038 in a step S69, and the process returns to the step S65. For example, when the processing in the step S69 is executed, the address data of the destination temporarily stored in the mail creation buffer 1034 is changed to the address data of “YAMADA *ROU” being the similar address data. In addition, if the address data is changed, a screen on which the similar address data is displayed is displayed on the display 30 as shown in FIG. 6(D).

Alternatively, if “NO” in the step S67, that is, in a case that the decide key 26e is pushed in a state that not the change key 84 but the return key 82 is selected by the cursor Cu, the process returns to the step S65. Furthermore, if the process returns to the step S65 without a change of the address data, the selected address data is displayed as shown in FIG. 6(B).

Furthermore, if the display key 80 is not operated in a state in FIG. 6(B) or FIG. 6(D), it is determined whether a consent operation or not in a step S71. For example, it is determined whether or not the decide key 26e is pushed in a state that the consent key 78 is selected by the cursor Cu. If “NO” in the step S71, that is, if a consent operation is not performed, the process returns to the step S65. Alternatively, if “YES” in the step 71, that is, if a consent operation is performed, the mail sending processing is executed in a step S73. For example, the processor 24 sends the data of the new e-mail stored in the mail creation buffer 1034 to the e-mail server not shown.

FIG. 11 is a flowchart showing the voice transmitting processing. When the user operates the address book key 26g to execute the voice transmitting processing, the processor 24 temporarily stores the address that is being selected in a step S91. Referring to FIG. 6(A), if the icon corresponding to the address data of “YAMADA #ROU” is selected by the cursor Cu, the address data of “YAMADA #ROU” is read from the address book data 1040 and temporarily stored in the selected address buffer 1036. Here, in this embodiment, when the address book data 1040 is displayed, one address data is always being selected.

Succeedingly, in a step S93, it is determined whether a voice transmitting operation or not. For example, it is determined whether or not the talk key is pushed. If “NO” in the step S93, that is, if it is not a voice transmitting operation, it is determined whether or not a re-selecting operation in a step S95. For example, it is determined whether or not the cursor key is pushed in order to operate the displayed cursor Cu in the step S95. If “NO” in the step S95, that is, it is not a re-selecting operation, the process returns to the step S93. On the other hand, if “YES” in the step S95, that is if the cursor key is operated, the process returns to the step S91 to temporarily store the newly selected address data. Here, the processing in the steps S93 and S95 is repetitively executed until the operation by the user.

Furthermore, if “YES” in the step S93, that is, if the talk key is pushed, it is determined whether or not the selected address is registered in the erroneous transmission preventive DB 1038 in a step S97. That is, it is determined whether or not the address data temporarily stored in the selected address buffer 1036 is included in the erroneous transmission preventive DB 1038. If “YES” in the step S97, that is, if the selected address data is registered in the erroneous transmission preventive DB 1038, the processing in the steps S99-S107 is executed. Here, the processing in the steps S99-S107 is the same as that in the steps S63-S71, and therefore, detailed explanation therefor is omitted.

On the other hand, If “NO” in the step S97, that is, if the selected address data is not registered in the erroneous transmission preventive DB 1038, the voice transmitting processing is executed in a step S109. That is, a phone number corresponding to the stored address data is read from the selected address buffer 1036, and the voice transmitting processing is executed on the basis of the phone number. Then, when the processing in the step S109 is ended, the voice transmitting processing is ended.

When a voice transmission or an e-mail sending is thus performed, if there is address data similar to the selected address data, the confirmation information is displayed, capable of surely preventing an erroneous transmission.

Here, the processor 24 executing the step S61 or the step S97 functions as a determiner. The processor 24 executing the step S63 or the step S99 functions as a displayer. Then, the processor 24 executing the step S69 or the step S105 functions as a changer.

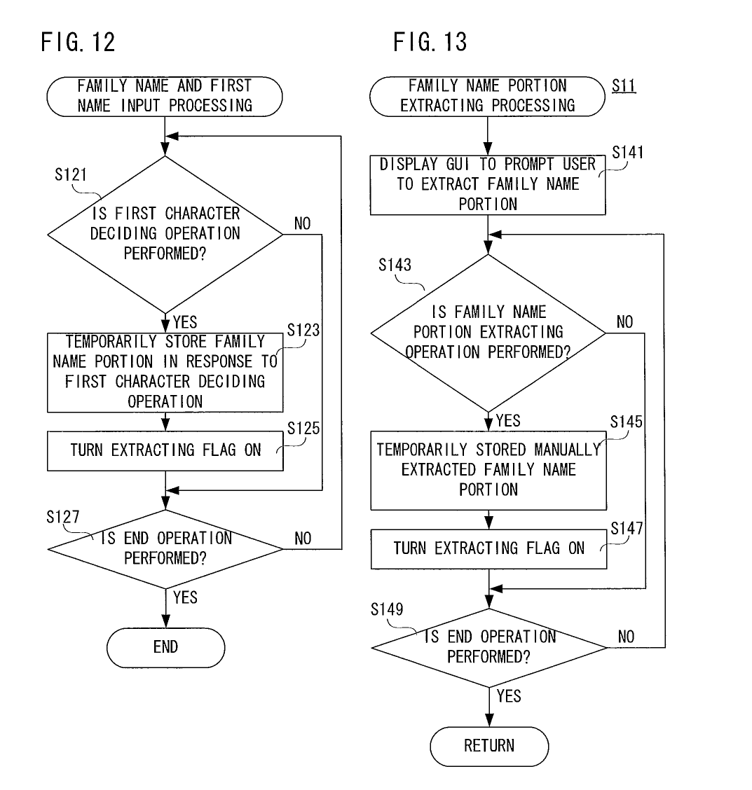

Additionally, in another embodiment, the extraction of the family name portion may be performed not based on the specific character, etc. such as a space, but based on an input operation of a character. FIG. 12 is a flowchart showing family name and first name inputting processing, for example. When an input operation is executed with respect to the family name and first name item 66, the processor 24 determines whether or not a first character deciding operation is performed in a step S121. For example, if it is determined whether or not the decide key 26e is pushed after the character string which has not yet been decided is input. If “NO” in the step S121, that is, if a first character deciding operation is not performed, the process proceeds to a step S127. On the other hand, if “YES” in the step S121, that is, if a first character deciding operation is performed, the family name portion is temporarily stored in response to the first character deciding operation in a step S123. For example, when the character string of “yamada” that is input as a character string which has not yet been decided is converted into the character string of “YAMADA” and then, the decide key 26e is pushed, the character string of “YAMADA” is extracted as a family name portion. Then, in the step S123, the extracted character string of the “YAMADA” is temporarily stored in the family name portion buffer 1032. Here, the processor 24 executing the processing in the step S123 functions as a deciding operation extractor.

Succeedingly, in a step S125, it is determined whether or not the extraction flag 1044 is turned on, and it is determined whether or not an end operation is performed in the step S127. That is, in the step S127, it is determined whether or not an operation of ending the input to the family name and first name item 66 is performed. If “NO” in the step S127, that is, if an end operation is not performed, the process returns to the step S121. On the other hand, if “YES” in the step S127, that is, if an end operation is performed, the family name and first name inputting processing is ended.

Thus, at a time of the determination of the family name portion, the family name portion is extracted in correspondence with the character deciding operation, and whereby, the user can unconsciously extract the family name portion.

Alternatively, in still another embodiment, the extraction of the family name portion may be performed based on a manual operation. FIG. 13 is a flowchart showing the family name portion extracting processing in the still another embodiment, for example. When the processing in the step S11 shown in FIG. 8 is executed, the processor 24 displays a GUI for prompting the user to extract the family name portion in a step S141. For example, the processor 24 displays a character string such as “designate a range for extracting the family name portion” and a GUI for prompting the user to designate a range for extracting the family name portion by the cursor key on the display 30.

Succeedingly, in a step S143, it is determined whether or not an operation of extracting the family name portion is performed. For example, it is determined whether or not the decide key 26e is pushed after a range for extracting the family name portion is selected by the cursor key. If “NO” in the step S143, that is, if an operation of extracting the family name portion is not performed, the process proceeds to a step S149. On the other hand, if “YES” in the step S143, that is, if a family name portion extracting operation is performed as described above, processing of temporarily storing the manually extracted family name portion is executed in a step S145. For example, if the character string of “YAMADA” is included in the range to be extracted, the character string of “YAMADA” is extracted as a family name portion and temporarily stored in the extraction buffer 1032. Here, the processor 24 executing the processing in the step S145 functions as an operation extractor.

Succeedingly, in a step S147, the extraction flag 1044 is turned on, and it is determined whether or not an end operation is performed in the step S149. That is, in the step S149, it is determined whether or not an operation of ending the operation of designating the range to be extracted of a family name portion is performed. If “NO” in the step S149, that is, if an end operation is not performed, the process returns to the step S143. On the other hand, if “YES” in the step S149, that is, if an end operation is performed, the family name portion extracting processing is ended, and the process returns to the new address creating processing.

Thus, by making the family name portion manually extractable, it becomes possible to accurately extract the family name portion.

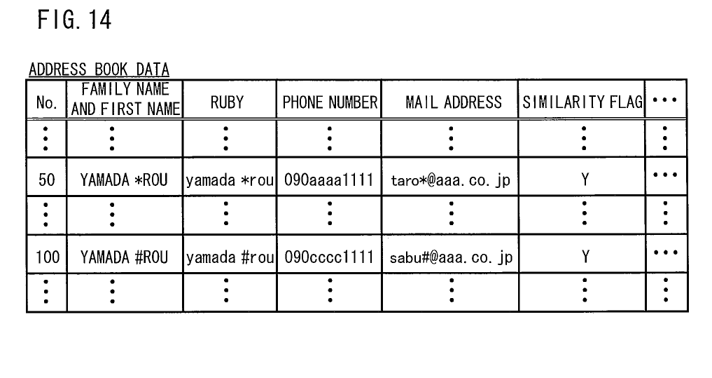

In a further embodiment, a flag (similarity flag) indicating similar address data is given to each of the address data making up of the address book data 1040, and whereby, the presence or absence of the address data having the same or similar family name portion can be determined without using the erroneous transmission preventive DB 1038. For example, with reference to FIG. 14, in the address book data of this embodiment, a column of the similarity flag is further provided. Then, “Y” indicating a similarity flag is recorded in the column of the similarity flag of the address data of “YAMADA *ROU” and “YAMADA #ROU”.

Furthermore, when a transmitting operation is performed, the processor 24 determines whether or not the similarity flag is given to the set address data. In addition, in a case that the similarity flag is given, the confirmation information is displayed as shown in FIG. 6(B). Then, when a displaying operation of the similar address data is performed, the address data which has the same character string and to which the similarity flag is given is read and displayed on the display 30 as similar address data.

For example, when a transmitting operation is performed on the basis of the address data of “YAMADA *ROU”, and a displaying operation of the similar data is performed, the address data of “YAMADA #ROU” which has the same character string and to which the similarity flag is given is read and displayed on the display 30.

Thus, an erroneous transmission can be prevented without creating the erroneous transmission preventive DB 1038, and therefore, it is possible to save the data capacity of the RAM 34.

In addition, in another embodiment, without using the erroneous transmission preventive DB 1038 and the similarity flag as well, with reference to only the address book data 1040, the presence or absence of the address data having the same or similar family name portion may be determined. In this case, the range to be searched is restricted on the basis of the ruby of the selected address data. For example, if the selected address data is “YAMADA #ROU”, the ruby is “yamada #rou”, and therefor, the range to be searched is restricted to only the address data after the Y line. Thus, without using the erroneous transmission preventive DB 1038 and the similarity flag, the advantage of the present application can be implemented only with the existing address book data. Thus, the designer of the mobile phone apparatus 10 is no need of taking care of the data capacity of the RAM 34. In addition, the range to be searched is restricted, capable of preventing the speed of the displaying processing of the confirmation information from being decreased.

Here, the plurality of embodiments can arbitrarily be combined, and the detailed combination can easily be imagined, and therefore, detailed explanation thereof is omitted.

As can be understood from the above description, the mobile phone apparatus 10 has the RAM 34 storing the address book data 1040, and the address book data 1040 is made up of the address data of “YAMADA *ROU” and “YAMADA #ROU”. Furthermore, when the user performs a transmitting operation on the key input device 26 in a state that the address data of “YAMADA #ROU” is selected, the processor 24 determines whether or not there is address data having the same as or similar to “YAMADA #ROU” in the address book data 1040. Then, if it is determined that there is the address data having the same or similar family name, the processor 24 displays the confirmation information on the display 30.

In this embodiment, since another address data that is different form the selected address data and has the same or similar family name portion is displayed at a time of a transmitting operation, an erroneous transmission is reduced.

Here, every time that new address data is registered, the extracted family name portion and address number may be registered in the erroneous transmission preventive DB 1038 irrespective of the presence or absence of the address data having the same or similar family name portion. Then, when a transmitting operation is performed, the processor 24 determines whether or not the address number of the set address data is registered in the erroneous transmission preventive DB 1038 to thereby determine whether or not there is the address data having the same or similar family name portion. Furthermore, the address data making up of the erroneous transmission preventive DB 1038 may arbitrarily be edited by the user.

Furthermore, in this embodiment, on the basis of JIS kanji character code, whether or not the family name portion is the same or similar is determined, but in a case that a character string (alphabetic characters, etc.) other than kanji characters is used in the family name and first name, other character codes, such as ASCII character code may be utilized.

In addition, in a case that the family name and first name is input by characters for which the family name portion is after the first name portion (alphabetic characters, for example), the latter-half portion may be extracted as a family name portion by regarding the specific character as a reference. Moreover, in a case that there are three or more address data having the same or similar family name portion, a key for displaying further another similar address data is displayed in FIG. 6(C). In addition, on the screen shown in FIG. 6(C), other information, etc. registered as address data may be displayed as well as the family name and first name and the mail address of the similar address data. For example, in a case that an occupation, an address and an image are registered in the address data of “YAMADA *ROU”, the occupation, the address and the image are displayed on the screen shown in FIG. 6(C). Thus, in the countries where people with the same or similar family name live (Chinese and Korea, for example), the user can identify the similar address data. Furthermore, in a case that a plurality of address data of the kin with the same family name are registered, the user can identify the similar address data.

Moreover, the present application can conform to a transmitting operation of SMS, etc. without being restricted to a voice transmission and e-mail sending if only the transmitting operation is based on the address data.

Furthermore, the shape of the mobile phone apparatus 10 may be a slide type, a flip type along the vertical axis or both of the vertical and the horizontal axes without being restricted to the straight type.

In addition, in the communication system of the mobile phone apparatus 10, a W-CDMA system, a GSM system, a TDMA system, a FDMA system, a PHS system, etc. may be adopted without being restricted to the CDMA system. In addition, as a display 30, an LCD monitor is utilized, but other displays devices, such as organic EL (ELECTRO LUMINNESCENSE) panel, etc. may be utilized.

Then, the present application may be applied to an electronic appliance, such as a smart phone, a PDA (Personal Digital Assistant), a notebook-sized PC (including a net book, etc.), etc. without being restricted to the mobile phone apparatus 10.

### Second Embodiment

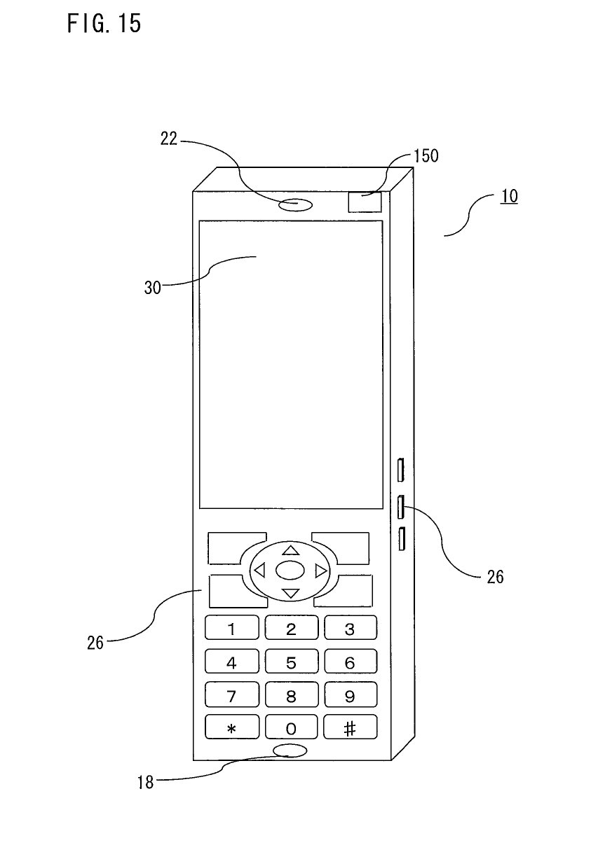

With reference to FIG. 15-FIG. 28, a mobile phone apparatus 10 of a second embodiment is explained. The outline of the second embodiment is first explained.

In the second embodiment, in a case that a destination of e-mail is selected from an address book, a telephone outgoing history, a telephone incoming history in a case of a telephone transmitting, and from an address book, a mail receiving history, a mail transmitting history in a case of an e-mail sending, a confirmation message for confirming whether or not the selected a phone call destination and a mail sending destination is correct is displayed. If there is an error in the selection, adjacent addresses are displayed as candidates to be changed. Thus, it is possible to prevent unintended telephone transmitting and e-mail sending from occurring. Here, the mail receiving history is displayed as a receiving history, the mail transmitting history is displayed as a transmitting history, the telephone outgoing history is displayed as an outgoing history, and the telephone incoming history is displayed as an incoming history, hereafter.

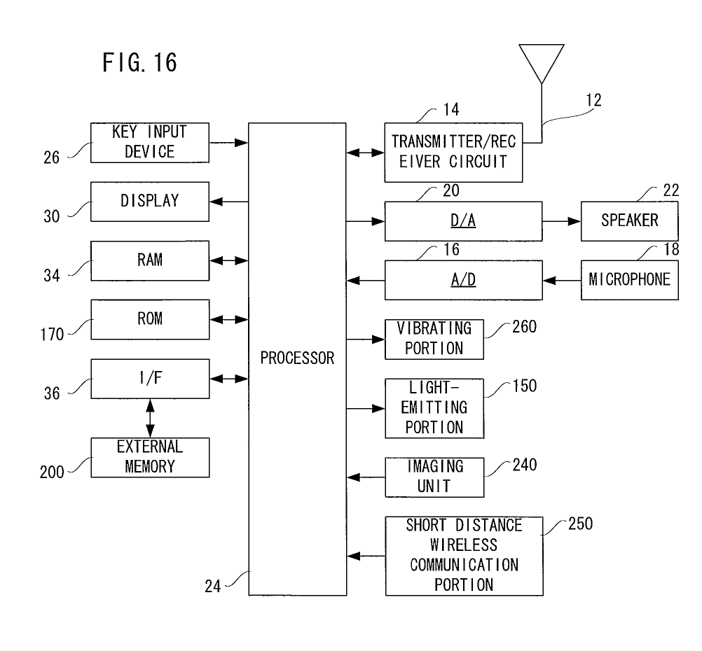

Next, a configuration of the mobile phone apparatus 10 being one embodiment of the second embodiment is explained by using FIG. 15 and FIG. 16.

FIG. 15 is an external perspective view of the mobile phone apparatus 10 being one example of the present invention. As an illustrated configuration, the mobile phone apparatus 10 is provided with a display 30, a key input device 26, a speaker 22, a microphone 18, and a light-emitting portion 150.

FIG. 16 is a structural view of the mobile phone apparatus 10 being one example of the present invention. The mobile phone apparatus 10 is made up of a processor 24, a key input device 26, a ROM 170 (READ ONLY MEMORY), a RAM 34, an I/F 36, an external memory 200, an A/D 16, a D/A 20, a vibrating portion 260, a light-emitting portion 150, an imaging unit 240, a short distance wireless communication portion 250, a display 30, a transmitter/receiver circuit 14, an antenna 12, a microphone 18, and a speaker 22.

The display 30 displays a screen required to implement functions provided to the mobile phone apparatus 10. The display 30 is formed of a liquid crystal display, an organic electroluminescence display (organic EL display), etc. The aforementioned display of the required screen includes a display of function menu, a display of received and sent e-mail, a display of transmitting history information and receiving history information, a display of address book data, a display of a camera image, a display of video images, a display of image data, etc.

The key input device 26 accepts an input operation from the user. The accepted input operation is input to the processor 24 as a control signal, and the processor 24 executes a function according to the control signal.

The speaker 22 is connected to the processor 24 via the D/A 20, and has a function of outputting a sound to outside. The D/A 20 converts a digital signal input from the processor 24 into an analog signal. The converted analog signal is output via the speaker 22.

The microphone 18 is connected to the processor 24 via the A/D 16, and accepts an input of a sound, etc. from outside. The input sound is output to the A/D 16 as an analog signal. The analog signal input to the A/D 16 is converted into digital signal and output to the processor 24.

The light-emitting portion 150 has a function of irradiating a light to outside in response to a control signal from the processor 24. For example, it is formed of a light emitter being typified by an LED, and notifies the user of an incoming call.

The processor 24 controls various functions and various pieces of hardware provided to the mobile phone apparatus 10. Furthermore, it executes various functions provided to the mobile phone apparatus 10 by an input from the key input device 26.

The ROM 170 stores a program for executing functions provided to the mobile phone apparatus 10. The processor 24 is accessible to the ROM 170, and reads the program required to execute the functions.

The RAM 34 is accessible from the processor 24, and utilized as a task storing area and a buffer area of the processor 24.

The I/F 36 is attached with a detachable external memory 200. The processor 24 can access to the external memory 200 via the I/F 36, and reads and executes the programs stored in the external memory 200. The external memory 200 needs only to be a medium storing programs, and is a memory card, an HDD (HARD DISC DRIVE), an SIM card, etc. Furthermore, the aforementioned program is not restricted to the programs that can directly be read from the external memory 200 so as to be executed, and includes an encoded program, a compressed program, image data, text data like mail text data, etc.

The vibrating portion 260 generates mechanic vibrations in response to a control signal from the processor 24. The vibrating portion 260 is formed of a motor, etc. for example, and informs the user of an incoming call, a mail receiving, arrival of alarmed date and time as mechanical vibrations.

The imaging unit 240 is provided with a camera function and a video function. The imaging unit 240 is formed of a CCD (CHARGE COUPLED DEVICE) camera, a CMOS (COMPLEMENTARY METAL OXIDE SEMICONDUCTOR) camera, etc.

The short distance wireless communication portion 250 performs a short distance wireless communication such as infrared communications, etc. The short distance wireless communication portion 250 transmits and receives transmission destination information registered in the address book and image data stored in a data folder with a communication partner nearby.

The transmitter/receiver circuit 14 performs demodulation processing and decode processing on a predetermined high frequency signal input from the antenna 12 to convert the same to a digital sound signal. Furthermore, it performs encoding processing and modulation processing on a digital sound signal input from the processor 24 to convert the same to a predetermined high frequency signal. Then, the transmitter/receiver circuit 14 outputs a predetermined high frequency signal to the antenna 12.

The antenna 12 receives an electromagnetic wave at a predetermined frequency to output the same as a predetermined high frequency signal to the transmitter/receiver circuit 14. Furthermore, it outputs a predetermined high frequency signal output from the transmitter/receiver circuit 14 as an electromagnetic wave at a predetermined frequency.

Here, the mobile phone apparatus 10 according to the second embodiment shall be a straight type mobile phone apparatus, but this may be a flip type mobile phone apparatus and a slide type mobile phone apparatus.

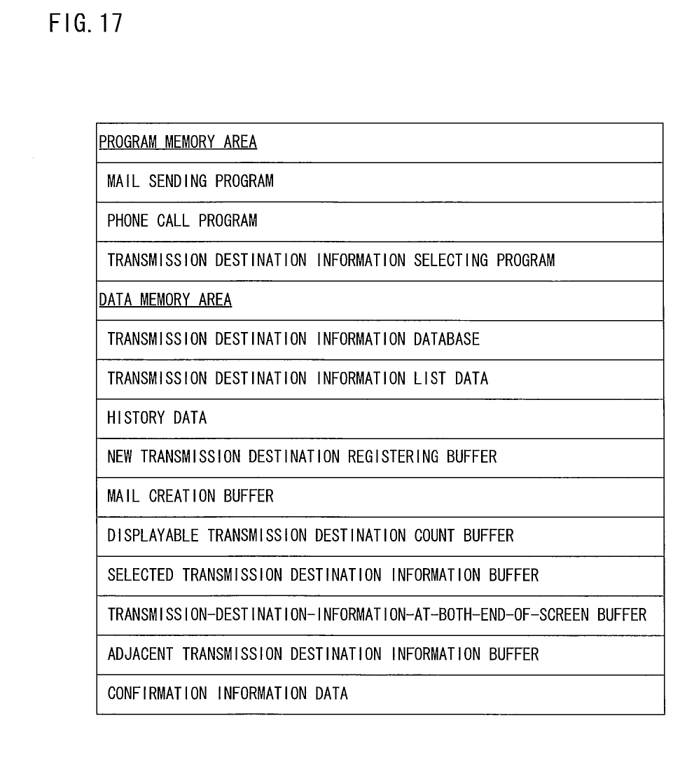

FIG. 17 shows information stored in the RAM 34 (hereinafter referred to as “memory map”). The memory map is made up of a program memory area and a data memory area. In the program memory area, a mail sending program, a phone call program, a transmission destination information selecting program, etc. are included. In the data memory area, a transmission destination information database, transmission destination information list data, history data, a new transmission destination registering buffer, a mail creation buffer, a displayable transmission destination count buffer, a transmission-destination-information-at-both-end-of-screen buffer, a selected transmission destination information buffer, an adjacent transmission destination information buffer, and confirmation information data are included.

First, the programs stored in the program memory area are explained. In the program memory area, the mail sending program, the phone call program, and the transmission destination information selecting program are stored.

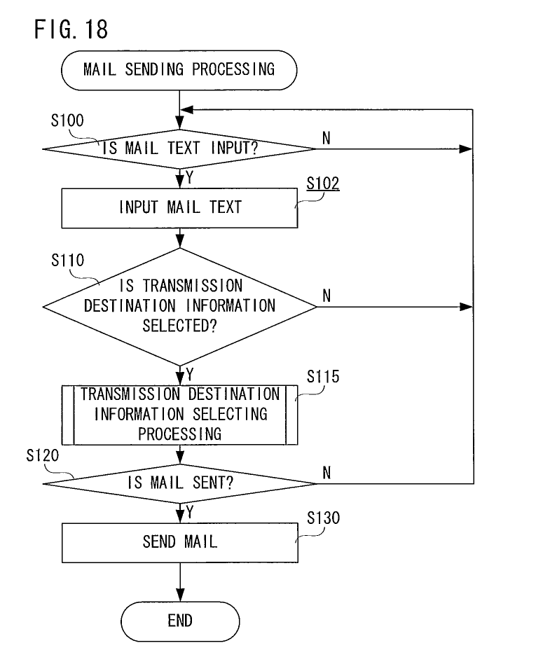

The mail sending program is a program for creating e-mail, and sending the e-mail to the designated sending destination. One example of a flowchart of the processing of the mail sending program is explained by using FIG. 18 later.

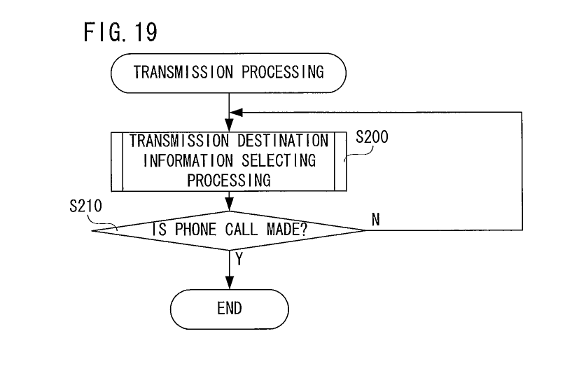

The phone call program is a program for making a phone call to a designated transmission destination. One example of a flowchart of the processing of the phone call program is explained by using FIG. 19 later.

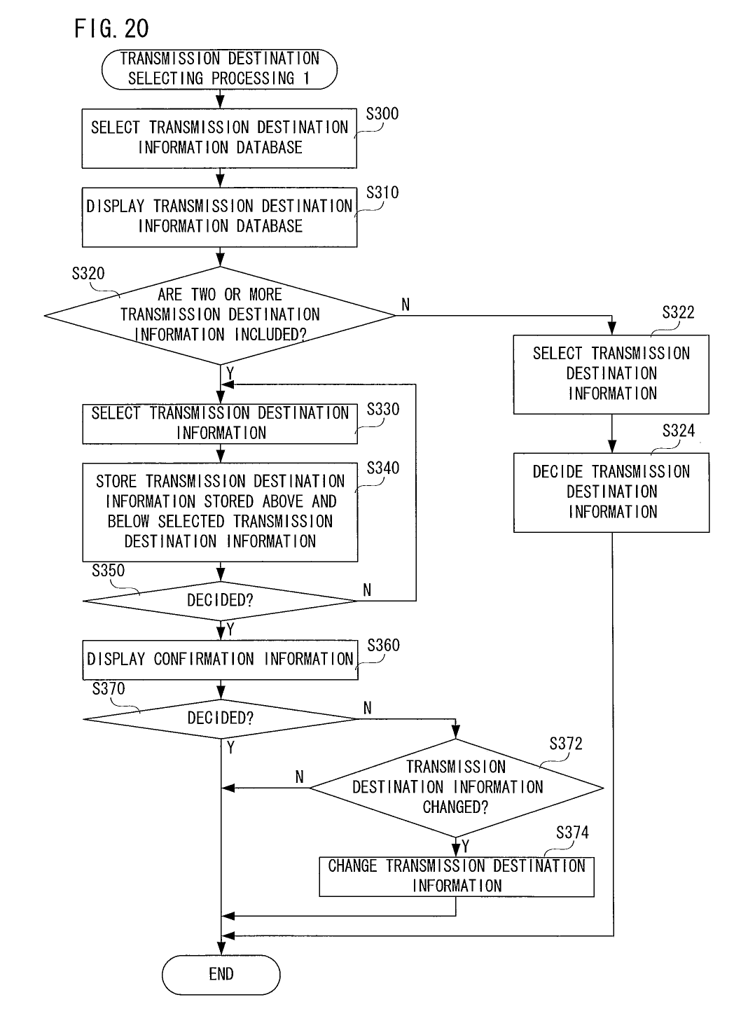

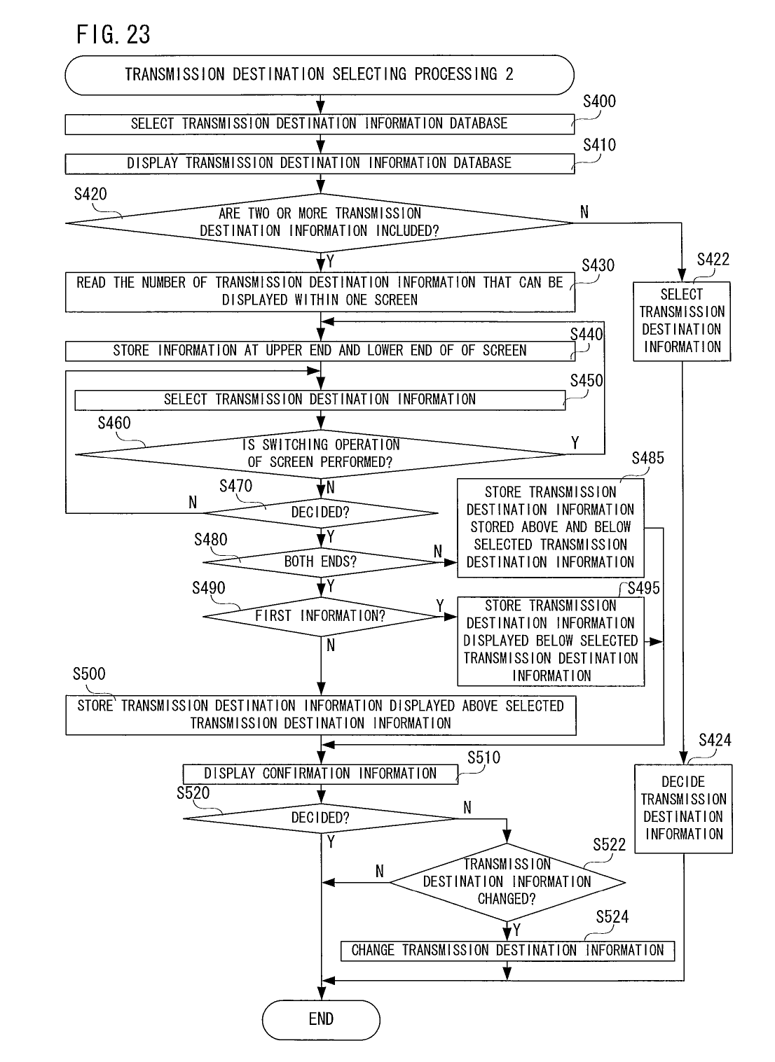

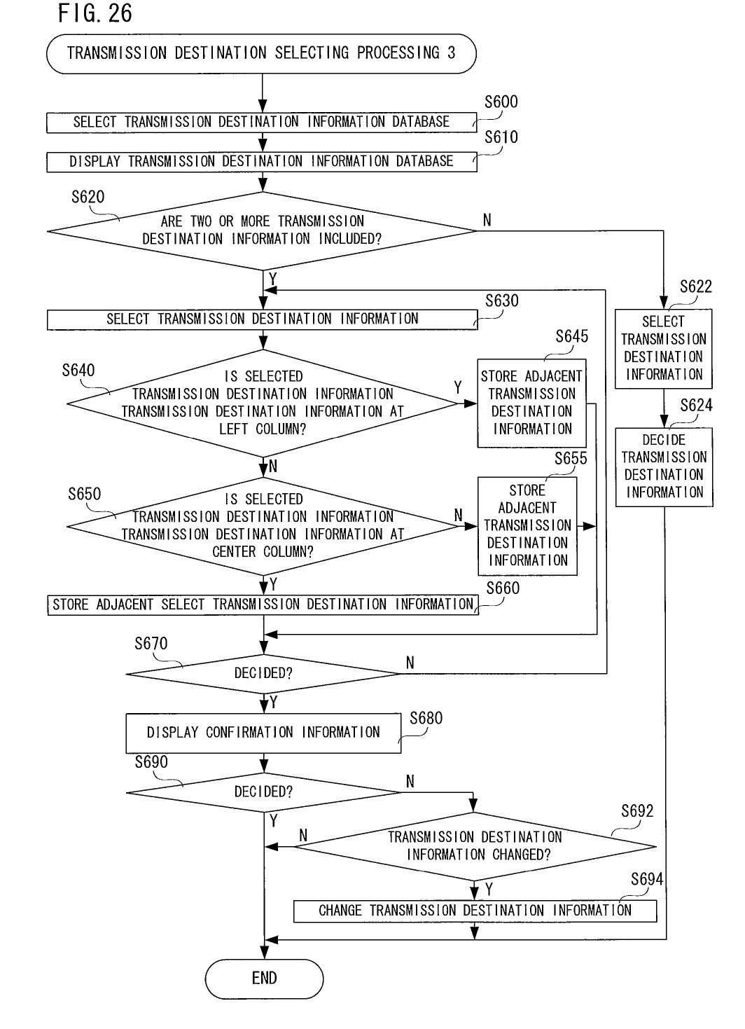

A transmission destination information selecting program is a program for selecting a mail sending destination and a transmission destination. One example of the flowchart of the processing of the transmission destination information selecting program is explained in FIG. 20, FIG. 23, and FIG. 26. The FIG. 20, FIG. 23, and FIG. 26 are explained in detail later. Next, an explanation is made on the data stored in the data memory area.

In the data memory area, the transmission destination information database, the transmission destination information list data, the history data, the new transmission destination registering buffer, the mail creation buffer, the displayable transmission destination count buffer, the selected transmission destination information buffer, the transmission-destination-information-at-both-end-of-screen buffer, the adjacent transmission destination information buffer, and the confirmation information buffer are stored.

In the transmission destination information database, the transmission destination information stored in the mobile phone apparatus 10 is stored. The transmission destination information is information including a memory number, a name, a phone number, a mail address, a group (information in relation to belonging, such as school, work), etc. The transmission destination information database is an address book, for example, and includes Japanese syllabry ordered name list data in which the transmission destination information is sorted by listing names according to the order of Japanese syllabary, memory number ordered list data in which the transmission destination information is sorted according to the order of a memory number, and group list data sorted by listing names according to the order of Japanese syllabary for each group.

The history data includes an outgoing history, an incoming history, a transmitting history, a receiving history, etc. In the history data, an occurring time of a matter is stored. For example, in a case of the outgoing history, transmission destination information or phone numbers as to the past phone calls are sorted according to a temporal order and stored. If there is transmission destination information (phone number, here) on which a phone call was made in the past in the transmission destination information database, the information registered in the transmission destination information database (name, memory number, for example) is displayed. In a case of the transmission destination information that is not registered in the transmission destination information database, the phone number is displayed on the display 30. Similarly, in a case of the transmitting history, a mail address on which a mail sending is performed or the information registered in the transmission destination information database (name, memory number, etc.) is displayed on the display 30. In a case of a mail address which is not registered in the transmission destination information database, the mail address is displayed on the display 30.

The new transmission destination registering buffer is a buffer for temporarily storing data including characters, numbers, an image, a setting of incoming call tone, etc. that are to be temporarily saved when the transmission destination information is newly registered in the transmission destination information database.

The mail creation buffer is a buffer for temporarily storing data including characters, numbers, pictogram, attaching data, transmission destination information, etc. that are to be temporarily saved at a time of creating e-mail.

The displayable transmission destination count buffer is a buffer for storing the number of transmission destinations to be displayed on the screen at a time. The displayable number of transmission destinations is decided on the basis of a screen size and a character size, and decided in advance at a time of manufacturing the mobile phone apparatus 10. Furthermore, this may be changed in correspondence with usage by the user as necessary.

The selected transmission destination information buffer is a buffer for temporarily storing the transmission destination information selected by the user from the designated transmission destination information database and history data in transmission destination selecting processing described later.

The transmission-destination-information-at-both-end-of-screen buffer is a buffer for storing each transmission destination information at both ends of the transmission destination list displayed on the screen.

The adjacent transmission destination information buffer is a buffer for temporarily storing the transmission destination information displayed so as to be adjacent to the transmission destination information selected by the user. The transmission destination information that is displayed so as to be adjacent thereto is explained in the description of the transmission destination information selecting processing shown in FIG. 20, FIG. 23, and FIG. 26.

The confirmation information data stores display information for, in a case that the transmission destination information is decided, confirming whether or not the selected transmission destination is correct.

Here, the information in relation to the aforementioned memory map is stored in the RAM 34, but may be stored in the external memory 200. In this case, the data of the external memory 200 is read in response to an instruction from the processor 24 via the I/F 36. In addition, the programs stored in the aforementioned program memory area and the data stored in the data memory are not restricted to the programs and data in FIG. 17, and includes the program and data necessary for executing the functions belonging to the mobile phone apparatus 10.

Mail sending processing is explained by using FIG. 18. The mail sending processing is processed by executing the mail sending program stored in the memory map.

In a case that the mail sending processing is started by an input from the key input device 26, it is determined whether or not the input from the key input device 26 is a mail text creating operation (S100). In a case of a mail text creating operation, inputting a mail text is performed (S102).

In a case of no mail text creating operation, it is determined whether a transmission destination information selecting operation or not (S110).

In a case of the transmission destination information selecting operation, transmission destination information selecting processing is performed (S115). The transmission destination information selecting processing is explained later. In a case of no transmission destination information selecting operation, it is next determined whether a mail sending operation or not (S120).

In a case of mail sending operation, a mail sending is executed (S130). In a case of no mail sending operation, the process returns to the processing in the S100.

Here, the determination order of the aforementioned mail text creation and transmission destination information selection may be changed as necessary.

The transmission processing is explained by using FIG. 19. The transmission processing is processed by executing the phone call program stored in the memory map.

In a case that a phone call operation is executed by an input to the key input device 26, the transmission destination selecting processing is first executed to select a phone call destination (S200).

Then, a phone call is made on the basis of the transmission destination information selected by the key input device 26 (S210).

Next, the transmission destination information selecting processing is explained. The transmission destination information selecting processing changes according to a display manner of the transmission destination information. As to the transmission destination selecting processing, three processing below are shown.

As an example of first processing, transmission destination information selecting processing 1 shown in FIG. 20 is first explained. In the processing example, a maximum of five transmission destination information read from the transmission destination information database are displayed on one screen, and new transmission destination information registered in the transmission destination information database that are read by a scroll of the screen according to an input by the key input device 26 are displayed according to a sorted order.

First, the transmission destination information database to be displayed on the display 30 is selected in order to select the transmission destination. As a transmission destination selecting list, the address book in the transmission destination information database and the outgoing history, the incoming history, the transmitting history, and the receiving history in the history data as shown in FIG. 17 are applicable (S300).

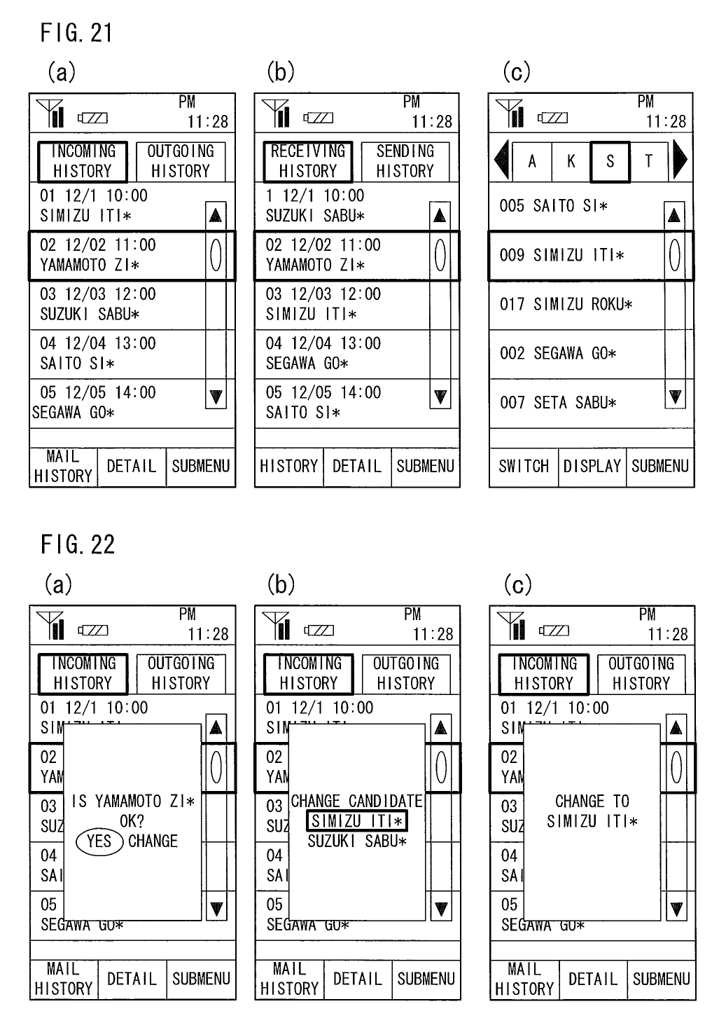

Next, the selected transmission destination selecting list is read from the RAM 34 so as to be output to the display 30. One example of the display screen is as shown in FIG. 21(a), FIG. 21(b), and FIG. 21(c) (S310).

Next, it is determined whether or not two or more transmission destination information are included in the displayed transmission destination selecting list (S320). If two or more transmission destination information are not included in the displayed transmission destination selecting list, that is, if one transmission destination information is displayed, a transmission destination information selecting operation (S322) and a decision operation (S324) are performed by the user, and then, the transmission destination information selecting processing 1 is ended.

On the other hand, if two or more transmission destination information are included in the displayed transmission destination selecting list, a selection of the transmission destination information is performed. The selection is performed by an input from the key input device 26 (S330).

Next, the transmission destination information displayed above and below the selected transmission destination information are temporarily stored in the adjacent transmission destination information buffer (S340).

Then, when the transmission destination information is decided by an input from the key input device 26 (S350), confirmation information is displayed on the display 30 (S360). One example of the confirmation information is illustrated in FIG. 22(a). If the selected transmission destination information is correct according to the confirmation information, “YES” displayed within the screen in FIG. 22 (a) is selected, and the transmission destination selecting processing is ended (S370).

If there is an error in the selected transmission destination information according to the confirmation information, a “CHANGE” button displayed at the center of the screen in FIG. 22(a) is selected by an input from the key input device 26 to make a transition to a change screen (S372). One example of the change screen is as shown in FIG. 22(b).

In FIG. 22(b), the transmission destination information temporarily stored in the adjacent transmission destination information are displayed. If a change to the displayed transmission destination information is desired to be made, the transmission destination information to which a change is desired to be made is selected (S374). Here, as one example of a screen display, a change screen when “YAMAMOTO ZI*” was selected is shown as shown in FIG. 22(a). When “YAMAMOTO ZI*” was selected, “SIMIZU ITI*” and “SUZUKI SABU*” are temporarily stored as adjacent transmission destination information. If a change to “SIMIZU ITI*” is to be made, “SIMIZU ITI*” is selected by an input from the key input device 26. If “SIMIZU ITI*” is selected, a change completion screen as illustrated in FIG. 22(c) is displayed, and the transmission destination selecting processing 1 is ended.

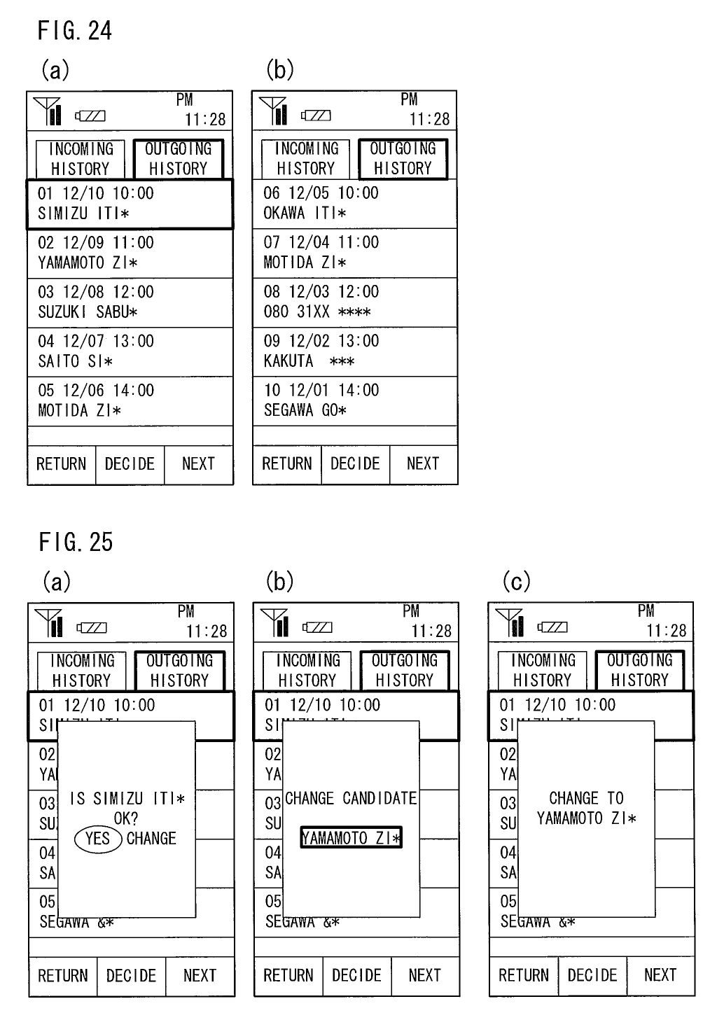

Next, an example of second processing is explained on the basis of FIG. 23 to FIG. 25. In this processing example, a maximum of five transmission destination information read from the transmission destination information database are displayed on one screen, and the transmission destination information can be switched to next new five transmission destination information according to a switch operation. The processing example shows transmission destination information selecting processing in the aforementioned display manner of the transmission destination information. Here, the switch operation is performed by selecting a “NEXT” button and a “RETURN” button at the lower part of the screen by an input from the key input device 26 in a case of one example of the display screen of the transmission destination information shown in FIG. 24(b).

In the transmission destination information selecting processing 2, the transmission destination information database to be displayed on the display 30 is first selected in order to select a transmission destination (S400). As a transmission destination information database to be displayed, the address book in the transmission destination information database and the outgoing history, the incoming history, the transmitting history and the receiving history in the history data as shown in FIG. 17 are applicable.

Next, the selected transmission destination information database is read from the RAM 34 so as to be output to the display 30 (S410). One example of the display screen of the transmission destination information is shown in FIG. 24(a) and FIG. 24(b). When the “NEXT” button or the “RETURN” button at the lower right part of the screen is selected by an input from the key input device 26, in the outgoing history displayed in FIG. 24(a), another maximum of five transmission destinations according to the arrangement order of the transmission destination information database is displayed on the display 30. One example when the “NEXT” button is selected to switch the display screen of the transmission destination information is shown in FIG. 24(b).

Then, it is determined whether or not two or more transmission destination information are included in the displayed transmission destination selecting list (S420).

If the two or more transmission destination information are included in the transmission destination selecting list, the process proceeds to processing in S430. If the two or more transmission destination information are not included in the transmission destination selecting list, that is, if one transmission destination information is displayed, a selecting operation (S422) and a decision operation (S424) of the transmission destination information from the user are performed, and then, the transmission destination information selecting processing 2 is ended.

Next, the number of transmission destination information that can be displayed within one screen is temporarily stored in the displayable transmission destination count buffer (S430). The displayable number of destinations of the transmission is decided depending on the character size and the screen size in advance, and is five in this embodiment.

Then, out of the transmission destination information displayed on one screen, the transmission destination information displayed at both ends of the screen are stored in the transmission-destination-information-at-both-end-of-screen buffer. Being displayed at both ends of the screen is the transmission destination information in relation to “SIMIZU ITI*” and “MOTIDA ZI*” in FIG. 24(a) (S440).

Next, a selection of the transmission destination information is performed (S450). The selection is performed by an input from the key input device 26.

Then, whether or not a switching operation of the screen is input by the key input device 26 is monitored (S460). If a switching operation of the screen is performed, the process returns to the S440 to update the

transmission-destination-information-at-both-end-of-screen buffer.

Next, whether or not an input of deciding the transmission destination information selected by the input from the key input device 26 is performed is monitored (S470).

Then, it is determined whether or not the decided transmission destination information is the transmission destination information stored in the transmission-destination-information-at-both-end-of-screen buffer (S480).

If it is not the transmission destination information stored in the transmission-destination-information-at-both-end-of-screen buffer, the transmission destination information displayed to be adjacent above and below the decided transmission destination information are temporarily stored in the adjacent transmission destination information buffer (S485).

If it is the transmission destination information stored in the transmission-destination-information-at-both-end-of-screen buffer, it is determined whether or not the decided transmission destination information is the transmission destination information displayed at the uppermost line of the transmission destination information database displayed on the display 30 (S490).

If the selected transmission destination information is the transmission destination information displayed at the uppermost line, the transmission destination information below the transmission destination information displayed at the uppermost line is temporarily stored in the adjacent transmission destination information buffer (S495). In the processing example, the transmission destination information directly arranged below the selected transmission destination information is temporarily stored in the displayed transmission destination information database.

If the selected transmission destination information is not the transmission destination information displayed at the uppermost line, that is, if it is the transmission destination information at the lowermost line, the transmission destination information above the transmission destination information at the lowermost line is temporarily stored in the adjacent transmission destination information (S500). In the processing example, the transmission destination information arranged directly above the selected transmission destination information is temporarily stored in the displayed transmission destination information database.

Next, in a case that the selected transmission destination information is decided by the input from the key input device 26, confirmation information is displayed. One example of the confirmation information is shown in FIG. 25(a) (S510).

If the selected transmission destination information is correct according to the confirmation information, the “YES” button displayed on the screen in FIG. 25(a) is selected by an input from the key input device 26, and the transmission destination selecting processing is ended (S520).

In a case that there is an error in the selected transmission destination information, a “CHANGE” button displayed at the center of the confirmation information screen in FIG. 25(a) is selected by an input from the key input device 26 to thereby make a transition to a change screen (S522). One example of the change screen is shown in FIG. 25(b). In FIG. 25(b), the transmission destination information temporarily stored in the adjacent transmission destination information buffer is displayed. If a change to the displayed transmission destination information is made, the transmission destination information to which a changed is desired to be made is selected by an input from the key input device 26 (S524). FIG. 25(b) shows a change screen when “SIMIZU ITI*” displayed in FIG. 25(a) was selected as one example of the screen display. If the “SIMIZU ITI*” was selected, “YAMAMOTO ZI*” is temporarily stored in the adjacent transmission destination information. If a change to “YAMAMOTO ZI*” is made, “YAMAMOTO ZI*” is selected by an input from the key input device 26.

If the “YAMAMOTO ZI*” is selected, a change completion screen shown in FIG. 25(c) is displayed, and then, a transmission destination selecting processing is ended.

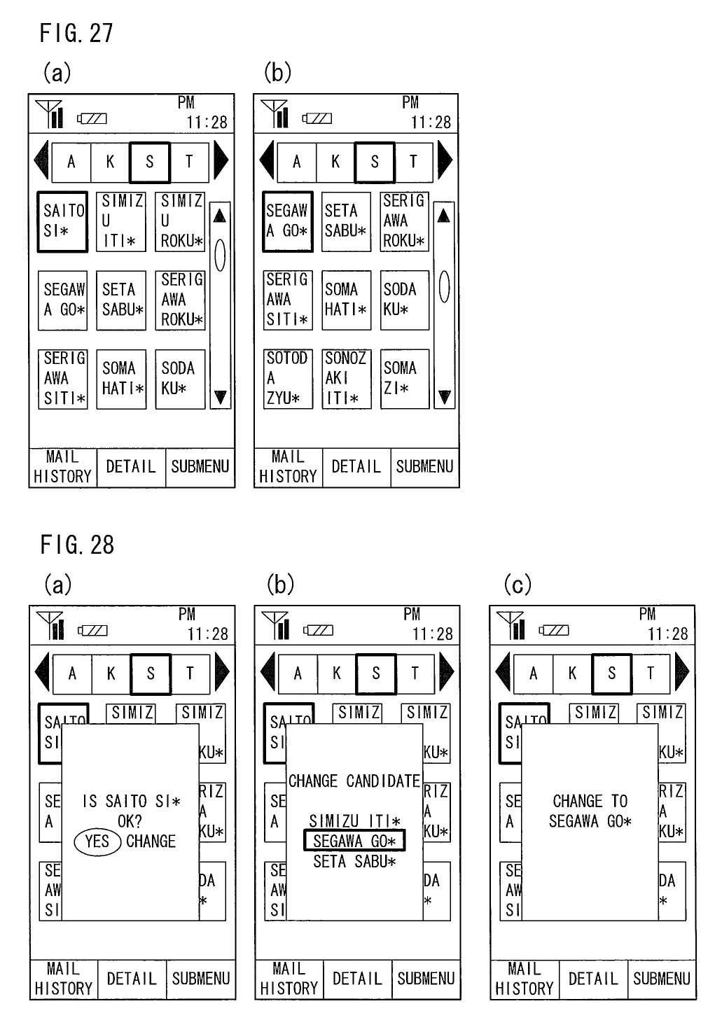

Next, transmission destination information selecting processing 3 shown in FIG. 26 is explained as a third processing example. FIG. 26 shows a flowchart of the transmission destination information selecting processing in a case that a maximum of nine transmission destinations read from the transmission destination information database are displayed on one screen. In this embodiment, the transmission destination database is displayed on the display 30 such that a switch of the screen of the displayed transmission destination information is performed by a scroll of the screen according to an input from the key input device 26. One example of the screen display of the transmission destination information is shown in FIG. 27(a) and FIG. 27 (b). Each of FIG. 27(a) and FIG. 27 (b) shows one example of the screen display of the transmission destination information obtained by sorting names according to the order of Japanese syllabary, but the outgoing history and the incoming history that are sorted according to a temporal order may be similarly displayed.

Here, in this example, other transmission destination information registered in the transmission destination information database read by scrolling the screen according to an input with the key input device 26 are displayed according the sorted order. FIG. 27(b) shows one example a screen display after a scroll operation is performed on the screen.

First, a transmission destination selecting database to be displayed on the display 30 for selecting a transmission destination is selected (S600). As a transmission destination selecting database, the address book in the transmission destination information database and the outgoing history, the incoming history, the transmitting history, and the receiving history in the history data are applicable as shown in FIG. 17.

Next, the selected transmission destination selecting list is read from the RAM 34 so as to be output to the display 30. One example of the display screen is shown in FIG. 27(a) and FIG. 27 (b) (S610).

Next, it is determined whether or not two or more transmission destination information are included in the displayed transmission destination selecting list. If two or more transmission destination information are not included in the transmission destination selecting list, a selecting operation (S622) and a decision operation (S624) of the transmission destination information by the user are performed, and then, the transmission destination information selecting processing 3 is ended.

If two or more transmission destination information are included in the transmission destination selecting list, the transmission destination information is selected by an input from the key input device 26 (S630).

Then, it is determined whether or not the selected transmission destination information is the transmission destination information at the left column (S640). The determination processing is performed by determining whether or not the selected transmission destination information is the transmission destination information at 1+3n (n=0, 1, 2, . . . )-th in the list of names sorted in the order of Japanese syllabary of the transmission destination information database stored in the RAM 34. If it is determined that the selected transmission destination information is the transmission destination information at the left column on the screen display, the transmission destination information stored third previous, second previous, directly after, third after, and fourth after the selected transmission information in the transmission destination information database are temporarily stored as adjacent transmission destination information (S645). As explained in detail by using FIG. 27(a), if “SAITO SI*” is selected, the transmission destination information of “SIMIZU ITI*”, “SEGAWA GO*”, and “SETA SABU*” are temporarily stored in the adjacent transmission destination information buffer.

If it is determined that the selected transmission destination information is not the transmission destination information at the left column of the screen display, it is then determined whether or not it is the transmission destination information displayed at the center column of the screen display (S650). The determination processing is performed by determining whether or not the selected transmission destination information is the transmission destination information at 2+3n (n=0, 1, 2, . . . )-th in the list of names sorted in the order of Japanese syllabary of the transmission destination information database stored in the RAM 34. If the selected transmission destination information is the transmission destination information displayed at the center column of the screen display, the transmission destination information stored forth previous, third previous, second previous, previous, directly after, second after, third after, and forth after the selected transmission destination information are temporarily stored as adjacent transmission destination information. In a case of the screen display shown in FIG. 27(a), if “SETA SABU*” is selected, the transmission destination information of “SAITO SI*”, “SIMIZU ITI*”, “SIMIZU ROKU*”, “SEGAWA GO*”, “SERIGAWA ROKU*”, “SERIGAWA SITI*”, “SOUMA HATI*”, “SODA KU*” are temporarily stored in the adjacent transmission destination information buffer.

If it is determined that the selected transmission destination information is not the transmission destination information displayed at the center column of the screen display, that is, if it is the transmission destination information displayed at the right column of the screen display and stored in the database, the transmission destination information stored forth previous, third previous, previous, second after, and third after in the transmission destination information database are temporarily stored as adjacent transmission destination information (S660). More specifically, in a case that “SODA KU*” is selected on the screen display shown in FIG. 27(b), the transmission destination information of “SETA SABU*”, “SERIGAWA ROKU*”, “SOUMA HATI*”, “SONOZAKI ITI*”, and “SOMA ZI*” are temporarily stored in the adjacent transmission destination information buffer.

Next, when the transmission destination information is decided by an input from the key input device 26 (S670), confirmation information is displayed on the display 30 (S680). One example of a screen display of the confirmation information is shown in FIG. 28(a).

If the selected transmission destination information is correct in accordance with the confirmation information, the “YES” button displayed on the screen in FIG. 28(a) is selected by an input from the key input device 26, and the transmission destination selecting processing is ended.

In a case that there is an error in the transmission destination information selected by the confirmation information, a “CHANGE” button displayed at the center of the screen in FIG. 28(a) is selected to make a transition to a change screen (S692). One example of a screen display of the change screen is displayed in FIG. 28(b). In FIG. 28(b), the transmission destination information temporarily stored in the adjacent transmission destination information are displayed on the display 30. If a change is made to the displayed transmission destination information, the transmission destination information to which the change is desired to be made is selected (S694). FIG. 28(b) shows a change screen when “SAITO SI*” displayed in FIG. 28(a) was selected as one example of the screen display. If “SAITO SI*” was selected, “SIMIZU ITI*” “SEGAWA GO*”, and “SETA SABU*” are temporarily stored in the in the adjacent transmission destination information. If a change to “SEGAWA GO*” is made, “SEGAWA GO*” is selected by an input with the key input device 26.

If a change to “SEGAWA GO*” is made, a change completion screen shown in FIG. 28(c) is displayed, and the transmission destination selecting processing is ended.

Here, a determining order among the left column, the center column, and the right column in this embodiment can be exchanged as necessary, and processing of determining the right column is performed depending on whether or not the selected transmission destination information is the transmission destination information at 3+3n (n=0, 1, 2, . . . )-th in the list of names sorted in the order of Japanese syllabary of the transmission destination information database stored in the RAM 34.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mobile phone apparatus having a transmission destination information database being made up of transmission destination information, selectively displaying the transmission destination information making up of said transmission destination information database, and capable of transmitting based on the transmission destination information, wherein
an operator which accepts a selecting operation of said transmission destination information, and accepts a transmitting operation to a transmission destination indicated by selected transmission destination information;
a determiner which determines whether or not transmission destination information in relation to said selected transmission destination information is included in said transmission destination information database when said operator accepts the transmitting operation based on said selected transmission destination information; and
a displayer which displays confirmation information when said determiner determines that the transmission destination information in relation to said selected transmission destination information is included.

2. A mobile phone apparatus according to claim 1, wherein
said transmission destination information includes a family name portion as information of a part of a family name and a first name, and
said determiner determines whether or not transmission destination information having the family name portion the same as or similar to the family name portion included in said selected transmission destination information is included in said transmission destination information database when said operator accepts the transmitting operation based on the selected transmission destination information, and
said displayer displays the confirmation information when said determiner determines that the transmission destination information having the same or similar family name portion is included.

3. A mobile phone apparatus according to claim 2, further comprising:
a storage which stores a erroneous transmission preventive database being made up of at least two or more transmission destination information having the same or similar family name portion, wherein
said determiner determines whether or not the transmission destination information having the family name portion the same as or similar to the family name portion included in said selected transmission destination information is included on the basis of said erroneous transmission preventive database.

4. A mobile phone apparatus according to claim 3, wherein
said operator further accepts a registering operation of new transmission destination information with respect to said transmission destination information database, further comprising:
an extractor which extracts a family name portion from said new transmission destination information; and
a register which, when there is the transmission destination information including the family name portion the same as or similar to the family name portion extracted by said extractor, registers the transmission destination information and the new transmission destination information in said erroneous transmission preventive database.

5. A mobile phone apparatus according to claim 4, wherein
said transmission destination information further includes a first name portion, and
said extractor includes a character extractor which extracts the family name portion on the basis of input information input between the family name portion and the first name portion.

6. A mobile phone apparatus according to claim 4, wherein
said operator further accepts a character input operation and a character deciding operation, and
said extractor includes a deciding operation extractor which extracts the family name portion in response to a first character deciding operation when the family name portion is input.

7. A mobile phone apparatus according to claim 4, wherein
said operator further accepts an extracting operation of the family name portion, and
said extractor further includes an extracting operation extractor, when said operator accepts an extracting operation, extracts the family name portion in response to the extracting operation.

8. A mobile phone apparatus according to claim 1, further comprising:
a changer which accepts an operation of changing the transmission destination information after said displayer displays the confirmation information.

9. A mobile phone apparatus according to claim 2, wherein
a flag indicating that it has the same or similar family name portion is given to each of at least two or more transmission destination information having the same or similar family name portion in said transmission destination information database, and
said determiner determines whether or not the transmission destination information having the family name portion the same as or similar to the family name portion included in said selected transmission destination information is included in said transmission destination information database on the basis of the flag given to said transmission destination information in said transmission destination information database.

10. A mobile phone apparatus according to claim 1, wherein
said transmission destination information further includes a phone number, and
said transmitting operation includes a voice transmitting operation.

11. A mobile phone apparatus according to claim 1, wherein
said transmission destination information further includes a mail address, and
said transmitting operation includes a mail sending operation.

12. A mobile phone apparatus according to claim 2, wherein
said confirmation information is information including the family name and the first name indicated by at least said selected transmission destination information.

13. A mobile phone apparatus according to claim 1, wherein
transmission destination information in relation to said selected transmission destination information is transmission destination information displayed to be adjacent to said selected transmission destination information, and further comprising:
a changing operation acceptor which accepts an operation of changing said selected transmission destination information when said displayer displays the confirmation information;
an adjacent transmission destination information displayer which displays the transmission destination information displayed to be adjacent to said selected transmission destination information when there is an operation of changing said selected transmission destination information;
a selecting operation acceptor which accepts an operation of selecting the transmission destination information displayed to be adjacent;
a deciding operation acceptor which accepts an operation of deciding the accepted transmission destination information as a transmission destination; and
a transmitter which performs a transmission to said accepted transmission destination information.

14. A mobile phone apparatus according to claim 13, wherein
said transmission destination information database includes at least one of an address book, a telephone incoming history, a telephone outgoing history, a mail receiving history, and a mail transmitting history.

15. A mobile phone apparatus according to claim 13, wherein
said transmission destination information displayed to be adjacent is transmission destination information that is displayed above and/or below said decided transmission destination information.

16. A mobile phone apparatus according to claim 13, wherein
said transmission destination information displayed to be adjacent is transmission destination information that is displayed above and/or below, right and/or left, diagonally upward right and/or diagonally downward left, and diagonally upward left and/or diagonally downward right.

17. A mobile phone apparatus having a transmission destination information database being made up of transmission destination information including a family name portion as information of a part of a family name and a first name, selectively displaying the transmission destination information making up of said transmission destination information database, and capable of transmitting based on the transmission destination information, comprising:
an operator which accepts a selecting operation of said transmission destination information, and accepts a transmitting operation to a transmission destination indicated by selected transmission destination information;
a determine which determines whether or not transmission destination information having a family name portion the same as or similar to the family name portion included in said selected transmission destination information is included in said transmission destination information database when said operator accepts the transmitting operation based on said selected transmission destination information; and
a displayer which displays confirmation information when said determiner determines that the transmission destination information having the same or similar family name portion is included.

18. A confirmation information displaying method of a mobile phone apparatus having a transmission destination information database being made up of transmission destination information including a family name portion as information of a part of a family name and a first name and an operator which accepts a selecting operation of said transmission destination information, and accepts a transmitting operation to a transmission destination indicated by selected transmission destination information, selectively displaying the transmission destination information making up of said transmission destination information database, and capable of transmitting based on the transmission destination information, including following steps of:
determining whether or not transmission destination information having the family name portion the same as or similar to the family name portion included in said selected transmission destination information is included in said transmission destination information database when said operator accepts the transmitting operation based on said selected transmission destination information; and
displaying confirmation information when it is determined that the transmission destination information having the same or similar family name portion is included.

19. A mobile phone apparatus, comprising:
a displayer which displays a plurality of transmission destination information;
a first selecting operation acceptor which accepts an operation of selecting one of the displayed transmission destination information;
a first deciding operation acceptor which accepts an operation of deciding the accepted transmission destination information as a transmission destination;
a confirmation displayer which displays a confirmation screen of said decided transmission destination information;
a changing operation acceptor which accepts an operation of changing said decided transmission destination information;
an adjacent transmission destination information displayer which displays transmission destination information displayed to be adjacent to said decided transmission destination information when there is an operation of changing said decided transmission destination information;
a second selecting operation acceptor which accepts an operation of selecting the transmission destination information displayed to be adjacent thereto;
a second deciding operation acceptor which accepts an operation of deciding the accepted transmission destination information as a transmission destination; and
a transmitter which performs a transmission to said accepted transmission destination information.

20. A transmitting method of a mobile phone apparatus, including steps of:
accepting an operation of selecting one of transmission destination information;
accepting an operation of deciding the accepted transmission destination information as a transmission destination;
displaying a confirmation screen of said decided transmission destination information;
accepting an operation of changing said decided transmission destination information;
displaying transmission destination information displayed to be adjacent to said decided transmission destination information when there is an operation of changing said decided transmission destination information;
accepting an operation of selecting the transmission destination information displayed to be adjacent;
accepting an operation of deciding the accepted transmission destination information as a transmission destination; and
performing a transmission to said accepted transmission destination information.
